(19) United States
(12) Patent Application Publication
(10) Pub. No.: US 2013/0289205 A1
(43) Pub. Date: Oct. 31, 2013

(54) RESIN COMPOSTION FOR LASER ENGRAVING, FLEXOGRAPHIC PRINTING PLATE PRECURSOR FOR LASER ENGRAVING AND PROCESS FOR PRODUCING SAME, AND FLEXOGRAPHIC PRINTING PLATE AND PROCESS FOR MAKING SAME

(71) Applicant: FUJIFILM CORPORATION, Tokyo (JP)

(72) Inventor: Atsushi SUGASAKI, Haibara-gun (JP)

(73) Assignee: FUJIFILM Corporation, Tokyo (JP)

(21) Appl. No.: 13/869,618

(22) Filed: Apr. 24, 2013

(30) Foreign Application Priority Data
Apr. 27, 2012 (JP) 2012-103091

(51) Int. Cl. B41N 1/12; B41N 3/03

(52) U.S. Cl. CPC B41N 1/12; B41N 3/032
USPC 524/854; 526/323.1; 525/217; 525/94; 264/400

(57) ABSTRACT

Disclosed is a resin composition for laser engraving, comprising: (Component A) a macroinitiator having a structure represented by any one of Formulae I to V below obtained by step-growth polymerization; and (Component B) a polymerizable compound.

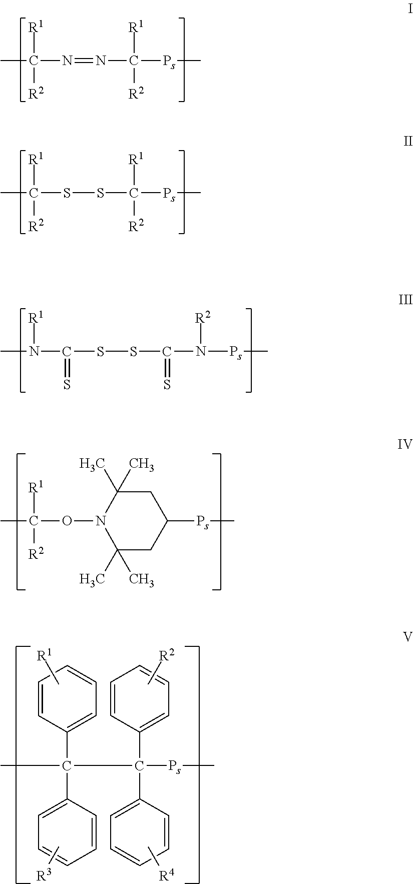

### CROSS-REFERENCE TO RELATED APPLICATION

This application claims priority under 35 USC 119 from Japanese Patent Application No. 2012-103091 filed on Apr. 27, 2012, the disclosure of which is incorporated by reference herein.

### BACKGROUND OF THE INVENTION

1. Technical Field

The present invention relates to a resin composition for laser engraving, a flexographic printing plate precursor for laser engraving, a process for producing same, a flexographic printing plate and a process for making same.

2. Background Art

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb a laser light and convert it into heat.

As a macroinitiator those described in JP-B-51-35514 and JP-A-2005-179640 (JP-A denotes a Japanese unexamined patent application publication and JP-B denotes a Japanese examined patent application publication) are known and as a resin composition for laser engraving comprising a macroinitiator JP-A-2012-45801 is known.

### SUMMARY OF THE INVENTION

### Problems to be Solved by the Invention

However, the present inventors have found that the conventional resin composition for laser engraving has the problem that it is difficult to obtain a flexographic printing plate having good durability toward both an aqueous ink and a solvent ink.

It is an object of the present invention to provide a resin composition for laser engraving that can give a flexographic printing plate having good durability toward both an aqueous ink and a solvent ink, a flexographic printing plate precursor employing the resin composition for laser engraving and a process for producing same, a process for making a flexographic printing plate employing same, and a flexographic printing plate obtained thereby.

It is another object of the present invention to provide a resin composition for laser engraving that can give a flexographic printing plate precursor having high engraving sensitivity and good rinsing properties for engraving residue, a flexographic printing plate precursor employing the resin composition for laser engraving and a process for producing same, a process for making a flexographic printing plate employing same, and a flexographic printing plate obtained thereby.

### Means for Solving the Problems

The objects of the present invention have been attained by means described in <1>, <9> to <11>, <13>, and <14>. They are described together with <2> to <8> and <12>, which are preferred embodiments.

<1> a resin composition for laser engraving, comprising (Component A) a macroinitiator having a structure represented by any one of Formulae I to V below obtained by step-growth polymerization and (Component B) a polymerizable compound,

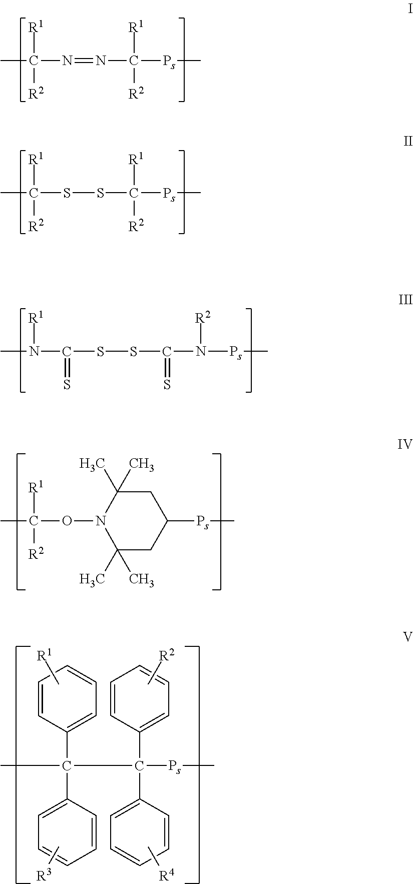

wherein in Formula I, Ps denotes a polysiloxane skeleton, in Formulae II to V, Ps denotes a main chain skeleton obtained by step-growth polymerization, and in Formulae I to V, R¹ to R⁴ independently denote a hydrogen atom, a halogen atom, or a monovalent organic group,
<2> the resin composition for laser engraving according to <1>, wherein Component A comprises a structure represented by Formula IV or Formula V,
<3> the resin composition for laser engraving according to <1> or <2>, wherein it further comprises (Component C) a binder having no polymerization-initiating ability,
<4> the resin composition for laser engraving according to any one of <1> to <3>, wherein Component B is at least one selected from the group consisting of a (meth)acrylic acid ester, a styrene, and acrylonitrile,
<5> the resin composition for laser engraving according to any one of <1> to <4>, wherein in Formulae II to V, Ps of Component A is at least one selected from the group consisting of a polyester skeleton, a polyurethane skeleton, a polyurethane urea skeleton, a polyamide skeleton, a polyalkylene glycol skeleton, and a polysiloxane skeleton,
<6> the resin composition for laser engraving according to any one of <1> to <5>, wherein Component B comprises a (meth)acrylate compound and a compound having at least one type from a hydrolyzable silyl group and a silanol group,
<7> the resin composition for laser engraving according to any one of <1> to <6>, wherein it further comprises (Component D) a photothermal conversion agent,
<8> the resin composition for laser engraving according to <7>, wherein Component D is carbon black,
<9> a flexographic printing plate precursor for laser engraving comprising a relief-forming layer comprising the resin composition for laser engraving according to any one of <1> to <8>,
<10> a flexographic printing plate precursor for laser engraving comprising a crosslinked relief-forming layer formed by crosslinking, by means of light and/or heat, a relief-forming layer comprising the resin composition for laser engraving according to any one of <1> to <8>,
<11> a process for producing a flexographic printing plate precursor for laser engraving, comprising a layer formation step of forming a relief-forming layer comprising the resin composition for laser engraving according to any one of <1> to <8> and a crosslinking step of crosslinking the relief-forming layer by means of light and/or heat to thus obtain a flexographic printing plate precursor comprising a crosslinked relief-forming layer,
<12> the process for producing a flexographic printing plate precursor for laser engraving according to <11>, wherein the crosslinking step is a step of crosslinking the relief-forming layer by means of heat to thus obtain a flexographic printing plate precursor comprising a crosslinked relief-forming layer,
<13> a process for making a flexographic printing plate, comprising an engraving step of laser-engraving a flexographic printing plate precursor for laser engraving comprising a crosslinked relief-forming layer formed by crosslinking a relief-forming layer comprising the resin composition for laser engraving according to any one of <1> to <8> by means of light and/or heat, to thus form a relief layer and
<14> a flexographic printing plate comprising a relief layer made by the process for making a flexographic printing plate according to <13>.

### DETAILED DESCRIPTION OF THE INVENTION

### Embodiments For Carrying Out the Invention

The present invention is explained in detail below.

In the present invention, the notation ‘lower limit to upper limit’, which expresses a numerical range, means ‘at least the lower limit but no greater than the upper limit’, and the notation ‘upper limit to lower limit’ means ‘no greater than the upper limit but at least the lower limit’. That is, it means a numerical range that includes the upper limit and the lower limit. Furthermore, ‘(Component A) a macroinitiator having a structure represented by any one of Formulae I to V obtained by step-growth polymerization’, etc. may simply be called ‘Component A’, etc.

### (Resin Composition for Laser Engraving)

The resin composition for laser engraving of the present invention (hereinafter, also simply called a ‘resin composition’) comprises (Component A) a macroinitiator having a structure represented by any one of Formulae I to V below obtained by step-growth polymerization and (Component B) a polymerizable compound.

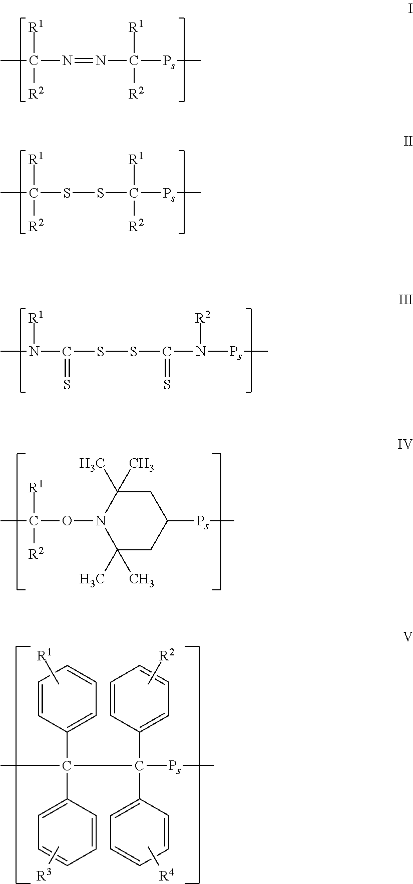

(In Formula I, Ps denotes a polysiloxane skeleton, in Formulae II to V, Ps denotes a main chain skeleton obtained by step-growth polymerization, and in Formulae I to V, R¹ to R⁴ independently denote a hydrogen atom, a halogen atom, or a monovalent organic group.)

Components contained in the resin composition for laser engraving of the present invention are explained below.

### (Component A) Macroinitiator Having Specific Structure Obtained by Step-Growth Polymerization

Component A is a specific macroinitiator (macromolecular initiator). The ‘macromolecule’ referred to here means one having a number-average molecular weight of at least 1,000. Measurement of number-average molecular weight here employs polystyrene conversion by GPC measurement. From the viewpoint of printing durability, the number-average molecular weight of Component A is preferably at least 5,000. Moreover, this initiator preferably has radical polymerization-initiating properties for an ethylenically unsaturated compound.

Component A has a structure (initiator residue) that thermally initiates radical polymerization and a structure (linking part) that links the initiator residue, and this linking part Ps is obtained by step-growth polymerization.

The ‘step-growth polymerization’ referred to here is polymerization, represented by a polycondensation reaction and a polyaddition reaction, in which a reaction product becomes a reagent for the following stage, and a series of elementary reactions occur in succession between reactive functional groups, that is, it is polymerization that progresses by repetition of a so-called step reaction. It is different in this regard from chain-growth polymerization, in which a polymerization initiator active structure initiates an addition reaction that transfers a chain to a monomer.

Furthermore, step-growth polymerization and chain-growth polymerization are described in for example ‘Kisokobunshikagaku’ (Basic Polymer Science), edited by the Society of Polymer Science, Japan, 2^{nd} Edition, 2006, published by Tokyo Kagaku Dojin.

A main chain skeleton obtained by step-growth polymerization is preferably a skeleton obtained by polyaddition or polycondensation, and more preferably a skeleton obtained by polyaddition.

Furthermore, the main chain skeleton obtained by step-growth polymerization may have at its terminal a linking group that bonds to another structure. The linking group need not be formed by step-growth polymerization or chain-growth polymerization.

Component A is a macroinitiator having a structure represented by any one of Formulae I to V above. Ps is preferably a divalent linking part. The macroinitiator has a partial structure represented by any one of Formulae I to V as a constituent unit, the number of repetitions n thereof preferably being an integer of 2 to 100. A molecular terminal (not illustrated) of Formulae Ito V is preferably a usual monovalent group such as a hydrogen atom, a lower (1 to 5 carbons) alkyl group, or a hydroxy group.

A main chain skeleton obtained by step-growth polymerization in Component A is preferably a skeleton selected from the group consisting of a polyester skeleton, a polyurethane skeleton, a polyurethane urea skeleton, a polyamide skeleton, a polyalkylene glycol skeleton, and a polysiloxane skeleton in Formulae II to V, and more preferably a skeleton selected from the group consisting of a polyester skeleton, a polyurethane skeleton, a polyalkylene glycol skeleton, and a polysiloxane skeleton.

With regard to the main chain skeleton obtained by step-growth polymerization in Component A, one type may be present on its own or two or more types may be present.

In Formula I, as a monomer that can be used in formation of a polysiloxane skeleton forming Ps of Component A, a silane compound and a silanol compound can be cited as examples.

In Formulae II to V, as a monomer that can be used in step-growth polymerization for forming Ps of Component A, a known step-growth polymerizable monomer may be used without particular limitation.

Examples of the step-growth polymerizable monomer include a polycarboxylic acid compound, a polycarboxylic acid halide compound, a polyol compound, a polyamine compound, a polyisocyanate compound, a silane compound, a silanol compound, an acid anhydride compound, and a hydroxycarboxylic acid compound. Furthermore, the step-growth polymerizable monomer is preferably a difunctional monomer.

Moreover, specific examples of the step-growth polymerizable monomer include the compounds below, but the present invention is not limited thereby.

Examples of the polycarboxylic acid compound and polycarboxylic acid halide compound include maleic acid, maleic anhydride, fumaric acid, itaconic acid, phthalic acid, isophthalic acid, phthalic anhydride, terephthalic acid, 2,6-naphthalenedicarboxylic acid, 2,7-naphthalenedicarboxylic acid, 2,3-naphthalenedicarboxylic acid, 2,3-naphthalenedicarboxylic acid anhydride, 4,4′-biphenyldicarboxylic acid, tetrahydrophthalic anhydride, tetrahydrophthalic acid, hexahydrophthalic acid, hexahydrophthalic anhydride, hexahydroterephthalic acid, hexahydroisophthalic acid, succinic acid, adipic acid, sebacic acid, oxalic acid, malonic acid, glutaric acid, suberic acid, sodium 5-sulfoisophthalate, and a compound formed by changing the carboxyl group of the polycarboxylic acid compound to a carboxylic acid halide group.

A polyamine compound is a compound having at least two primary amino groups and is preferably a diamine having only two primary amino groups in a molecule.

Examples of the polyamine include aliphatic polyamines such as hexanediamine, ethylenediamine, diethylenetriamine, triethylenetetramine, tetraethylenepentamine, m-xylenediamine and p-xylenediamine, alicyclic polyamines such as 1,3-diaminocyclohexane and isophoronediamine, polyanilines such as 1,4-phenylenediamine, 2,3-diaminonaphthalene, 2,6-diaminoanthraquinone, 2,2-bis(4-aminophenyl)hexafluoropropane, 4,4′-diaminobenzophenone and 4,4′-diaminodiphenylmethane, Mannich bases consisting of a polycondensate of polyamines, an aldehyde compound, and mono- or polyvalent phenols, and polyamidopolyamines obtained by the reaction of polyamines with polycarboxylic acid or dimer acid.

A polyol compound is a compound having at least two hydroxy groups and is preferably a diol having only two hydroxy groups in a molecule.

Examples of the polyol include ethylene glycol, diethylene glycol, propylene glycol, dipropylene glycol, trimethylene glycol, 1,4-tetramethylenediol, 1,3-tetramethylenediol, 2-methyl-1,3-trimethylenediol, 1,5-pentamethylenediol, neopentyl glycol, 1,6-hexamethylenediol, 1,7-heptanediol, 1,8-octanediol, 1,9-nonanediol, 1,10-decanediol, 3-methyl-1,5-pentamethylenediol, 2,4-diethyl-1,5-pentamethylenediol, glycerin, trimethylolpropane, trimethylolethane, hydroquinone, cyclohexanediols (such as 1,4-cyclohexanediol), bisphenols (such as bisphenol A, 4,4′-diphenol), sugar alcohols (such as xylitol and sorbitol); polyalkylene glycols such as polyethylene glycol, polypropylene glycol and polytetramethylene glycol; novolak resins such as a phenol novolak resin, a cresol novolak resin, a naphthol novolak resin; polyfunctional phenol resins such as a triphenolmethane-derived resin; modified phenol resins such as a dicyclopentadiene-modified phenol resin, modified phenol resins such as a terpene-modified phenol resin; various aralkyl-type resins such as a phenol aralkyl resin having phenylene groups, a phenol aralkyl resin having biphenylene groups, a naphthnol aralkyl resin having phenylene groups, a naphthnol aralkyl resin having biphenylene skeletons; bisphenol compounds such as bisphenol A, bisphenol F; and sulphur atom-containing phenol resins derived from bisphenol S, etc.

A polyisocyanate compound is a compound having at least two isocyanate groups and is preferably a diisocyanate compound having only 2 isocyanate groups in a molecule.

Examples of the polyisocyante compounds include m-phenylene diisocyanate, p-phenylene diisocyanate, 2,6-tolylene diisocyanate, 2,4-tolylene diisocyanate, naphthalene-1,4-diisocyanate, diphenylmethane-4,4′-diisocyanate, 3,3′-dimethoxy-biphenyl diisocyanate, 3,3′-dimethyldiphenylmethane-4,4′-diisocyanate, xylylene-1,4-diisocyanate, xylylene-1,3-diisocyanate, 4-chloroxylylene-1,3-diisocyanate, 2-methylxylylene-1,3-diisocyanate, hydrogenated xylylene-1,4-diisocyanate, hydrogenated xylylene-1,3-diisocyanate, 4,4′-diphenylpropane diisocyanate, 4,4′-diphenylhexafluoropropane diisocyanate, trimethylene diisocyanate, hexamethylene diisocyanate, propylene-1,2-diisocyanate, butylene-1,2-diisocyanate, cyclohexylene-1,2-diisocyanate, cyclohexylene-1,3-diisocyanate, cyclohexylene-1,4-diisocyanate, dicyclohexylmethane-4,4′-diisocyanate, 1,4-bis(isocyanatomethyl)cyclohexane, 1,3-bis(isocyanatomethyl)cyclohexane, isophorone diisocyanate, diisocyanatomethyl norbornane, lysine diisocyanate, and the like. Moreover, products of an addition reaction between these bifunctional isocyanate compounds and bifunctional alcohols or phenols such as ethylene glycols or bisphenols can also be used.

Examples of the silane compounds include methyltrimethoxysilane, methyltriethoxysilane, phenyltrimethoxysilane, phenyltriethoxysilane, dimethyldimethoxysilane, dimethyldiethoxysilane, diphenyldimethoxysilane, diphenyldiethoxysilane, tetramethoxysilane, and tetraethoxysilane. Examples of the silanol compound include partially hydrolized compounds of the above-mentioned silane compounds.

Examples of the acid anhydride compound include succinic anhydride, maleic anhydride, phthalic anhydride, hexahydrophthalic anhydride, methylhexahydrophthalic anhydride, nadic anhydride, hydrogenated nadic anhydride, trimellitic anhydride, and pyromellitic anhydride.

Examples of the hydroxycarboxylic acid compound include hydroxyoctanoic acid, hydroxynonanoic acid, hydroxydecanoic acid, hydroxyundecanoic acid, hydroxydodecanoic acid, hydroxytetradecanoic acid, hydroxytridecanoic acid, hydroxyhexadecanoic acid, hydroxypentadecanoic acid, and hydroxystearic acid.

Specific macroinitiators represented by Formulae I to V are explained in sequence below.

As the macroinitiator having a main chain skeleton obtained by step-growth polymerization, from the viewpoint of synthetic yield or solvent ink durability, a macroinitiator having a constituent unit represented by Formulae I to V below is used. Among them, a macroinitiator having a constituent unit represented by Formula III, Formula IV, or Formula V below is preferable, and from the viewpoint of ink laydown and printing durability, a compound having a constituent unit represented by Formula IV or Formula V below is more preferable. As described above, a molecular terminal (not illustrated) of Formulae I to V is preferably a hydrogen atom, a lower (1 to 5 carbons) alkyl group, or a hydroxy group.

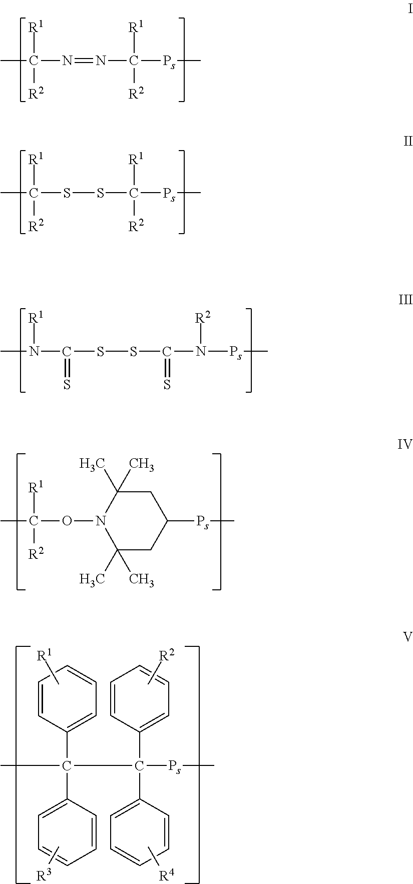

(In Formula I, Ps denotes a polysiloxane skeleton, in Formulae II to V, Ps denotes a main chain skeleton obtained by step-growth polymerization, and R¹ to R⁴ independently denote a hydrogen atom, a halogen atom, or a monovalent organic group.)

In Formula I, Ps denotes a polysiloxane skeleton, in Formulae II to V, the main chain skeleton obtained by step-growth polymerization and denoted by Ps has the same meaning as the main chain skeleton obtained by step-growth polymerization described above and preferred embodiments thereof are also the same as described above.

Examples of the monovalent organic group denoted by R¹ to R⁴ include an alkyl group, an aryl group, a heterocyclic group, a heteroaromatic group, an alkoxy group, an aryloxy group, an alkylthio group, an arylthio group, an amino group, a hydroxy group, a cyano group, an alkoxycarbonyl group, an aryloxycarbonyl group, a carboxyl group, an acyl group, and an amide group. Furthermore, the monovalent organic group may be further substituted with a substituent. Examples of the substituent include a halogen atom and a group cited for the monovalent organic group.

With regard to R¹ to R⁴, two or more thereof may be bonded to each other, or any one or two or more of R¹ to R⁴ and another structure may be bonded.

Furthermore, the monovalent organic group denoted by R¹ to R⁴ preferably has 1 to 60 carbons, more preferably 1 to 30, and yet more preferably 1 to 20. The lower limit number of carbons in an aryl group is 6.

Specific preferred examples of the compound having a constituent unit represented by Formula I include a compound having a constituent unit represented by Formula I-1 or Formula I-2 below, and more preferred examples include a compound having a constituent repeating unit represented by Formula I-1 below.

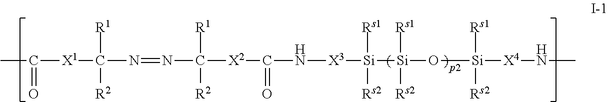

(In the Formulae, R¹ and R² independently denote a lower alkyl group having 1 to 6 carbons or a cyano group, R^{s1} and R^{s2} independently denote a lower alkyl group having 1 to 10 carbons or an aryl group, X¹ to X⁴ independently denote a lower alkylene group having 1 to 10 carbons, and p1 and p2 independently denote a positive integer.)

The lower alkyl group denoted by R¹, R², R^{s1}, and R^{s2} in Formula I-1 above may be straight-chain or branched and is preferably an alkyl group having 1 to 6 carbons. Specific examples include a methyl group, an ethyl group, an n-propyl group, an isopropyl group, an n-butyl group, an isobutyl group, a tert-butyl group, a sec-butyl group, an n-pentyl group, an isopentyl group, a tert-pentyl group, a neopentyl group, an n-hexyl group, an isohexyl group, a 1-methylpentyl group, and a 2-methylpentyl group.

Examples of the aryl group denoted by R^{s1} and R^{s2} in Formula I-1 above include a phenyl group, an o-tolyl group, an m-tolyl group, a p-tolyl group, a 2,3-xylyl group, a 2,4-xylyl group, a 2,5-xylyl group, a 2,6-xylyl group, a 3,5-xylyl group, and a naphthyl group.

The lower alkylene group denoted by X¹ to X⁴ in Formula I-1 above may be straight-chain, branched, or cyclic. Specific examples include an alkylene group having 1 to 10 carbons such as a methylene group, an ethylene group, a propylene group, a butylene group, a 2-methylpropylene group, a pentylene group, a 2,2-dimethylpropylene group, a 2-ethylpropylene group, a hexylene group, a heptylene group, an octylene group, a 2-ethylhexylene group, a nonylene group, a decylene group, a cyclopropylene group, a cyclopentylene group, and a cyclohexylene group. Among them, X¹ to X⁴ are preferably an alkylene group having 1 to 6 carbons.

p1 and p2 in Formula I-1 and Formula I-2 above are preferably independently an integer of 1 to 200, and more preferably an integer of 1 to 100.

It is particularly preferable in Formula I-1 above that R¹ is a methyl group and R² is a cyano group.

As the compound represented by Formula I or Formula I-1, a commercial product may be used, and examples include the macro azo initiator VSP series from Wako Pure Chemical Industries, Ltd., and specifically VPS-1001 (which has a polydimethylsiloxane unit, the molecular weight of this unit being about 10,000).

A compound represented by Formula I-1 is preferred to a macro azo initiator having a poly-alkyleneoxy group as Ps since a relief layer is formed that has suppressed ink swelling. This is because in Formula I-1, Ps is a polysiloxane skeleton, which has high hydrophobicity, and a hydrophobic block is introduced into poly-addition product of Component B.

The compound having a constituent unit represented by Formula II above is preferably a compound in which a disulfide structure is formed from a disulfide compound-derived structure having two hydroxy groups, and more preferably a polyurethane resin obtained by polycondensation of a disulfide compound having two hydroxy groups, a diol compound other than the disulfide compound, and a diisocyanate compound, or a polyester resin obtained by polycondensation of a disulfide compound having two hydroxy groups, a diol compound other than the disulfide compound, and a dicarboxylic acid compound, dicarboxylic acid halide compound and/or acid anhydride compound.

Ps in Formula II above is preferably a polyester skeleton, a polyurethane skeleton, or a polysiloxane skeleton.

Preferred examples of the disulfide compound having two hydroxy groups include the compounds below.

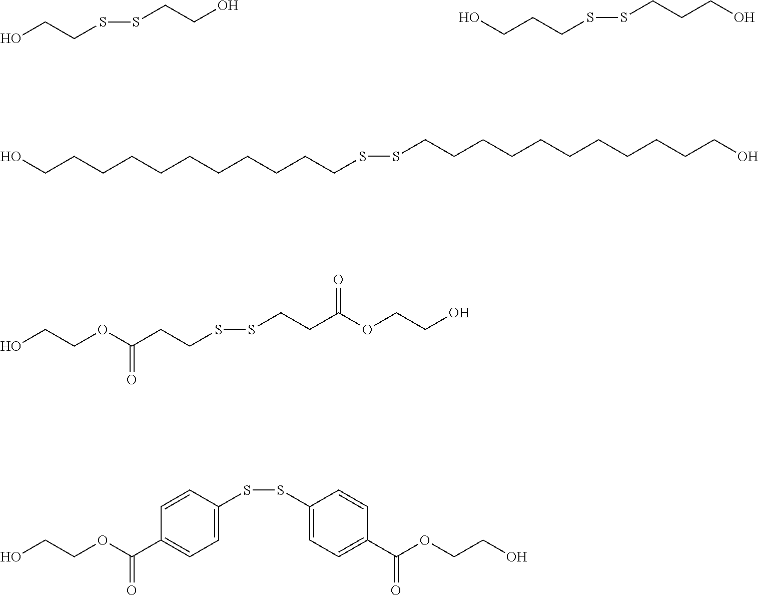 [SMILES: OCCSSCCO ; OCCCSSCCCO ; OCCCCCCCCCCCSSCCCCCCCCCCCO ; O=C(CCSSCCC(=O)OCCO)OCCO ; O=C(OCCO)c1ccc(SSc2ccc(C(=O)OCCO)cc2)cc1]

The compound having a constituent unit represented by Formula III above is preferably a compound in which a structure represented by Formula III-1 below is formed from a structure derived from a compound having two amino groups and a structure represented by Formula III-1 below, and more preferably a polyamide resin obtained by polycondensation of a compound having two amino groups and a structure represented by Formula III-1 below, a diamino compound other than the compound above, and a dicarboxylic acid compound, dicarboxylic acid halide compound and/or acid anhydride compound.

Ps in Formula III above is preferably a polyester skeleton, a polyurethane skeleton, or a polysiloxane skeleton.

Preferred examples of the compound having two amino groups and a structure represented by Formula III-1 below include a compound represented by Formula III-2.

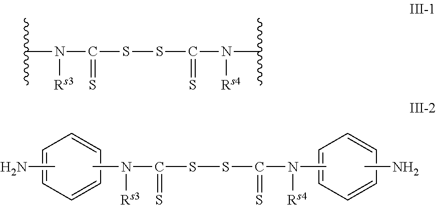

(In the Formulae, R^{s3} and R^{s4} independently denote a hydrogen atom, an alkyl group, an aryl group, a haloalkyl group, a cyanoalkyl group, or an alkoxyalkyl group, and a wavy line portion denotes the position of bonding to another structure.)

From the viewpoint of synthetic yield, the compound having a constituent unit represented by Formula IV above is preferably a compound having a constituent unit represented by Formula IV-1 or Formula IV-2 below, more preferably a compound having a constituent unit represented by Formula IV-1 or Formula IV-2 below in which Ps is a polyester skeleton, a polyurethane skeleton or a polysiloxane skeleton and, from the viewpoint of printing durability, yet more preferably a compound having a constituent unit represented by Formula IV-1 or Formula IV-2 below in which Ps is a polyurethane skeleton or a polysiloxane skeleton.

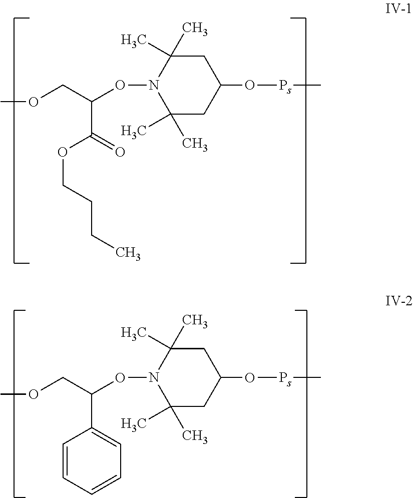

(In the Formulae, Ps denotes a main chain skeleton obtained by step-growth polymerization.)

The compound having a constituent unit represented by Formula V above is preferably a compound having a constituent unit represented by Formula V-1 or Formula V-2 below, and more preferably a compound having a constituent unit represented by Formula V-1 below. Furthermore, the compound having a constituent unit represented by Formula V above is preferably a compound having a constituent repeating unit represented by Formula V-1 or Formula V-2 below.

Furthermore, Ps in Formula V-1 below is preferably a polyurethane skeleton, a polyester skeleton, or a polysiloxane skeleton, and more preferably a polyurethane skeleton. Moreover, Ps in Formula V-2 below is preferably a polyurethane urea skeleton, a polyamide skeleton, or a polysiloxane skeleton.

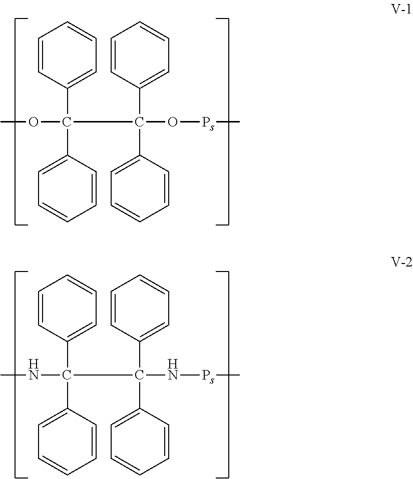

(In the Formulae, Ps denotes a main chain skeleton obtained by step-growth polymerization.)

The content of Component A contained in the resin composition for laser engraving is preferably 3 to 50 mass % relative to the total solids content, more preferably 5 to 40 mass %, yet more preferably 10 to 35 mass %, and particularly preferably 15 to 25 mass %. When in this range, a relief-forming layer formed from the resin composition for laser engraving has excellent printing durability.

### (Component B) Polymerizable Compound

The resin composition for laser engraving of the present invention comprises (Component B) a polymerizable compound.

‘Polymerization’ in the present invention includes not only sequential polyaddition polymerization in the narrow term but also polycondensation or polyaddition.

The polymerizable compound that can be used in the present invention is not particularly limited as long as it is polymerizable, and a known compound may be used. Specific preferred examples include an ethylenically unsaturated compound, a silane compound, a polycarboxylic acid compound, a polycarboxylic acid halide compound, a polyol compound, a polyamine compound, a polyisocyanate compound, an acid anhydride compound, and a hydroxycarboxylic acid compound.

The silane compound in Component B is preferably a compound comprising at least one type from a hydrolyzable silyl group and a silanol group, which are described later.

Furthermore, the ethylenically unsaturated compound in Component B is preferably a polyfunctional ethylenically unsaturated compound which has at least two ethylenically unsaturated groups.

Among them, Component B is preferably an ethylenically unsaturated compound and/or a compound comprising at least one type from a hydrolyzable silyl group and a silanol group, and is more preferably an ethylenically unsaturated compound and a compound comprising at least one type from a hydrolyzable silyl group and a silanol group. When in this embodiment, a flexographic printing plate having excellent printing durability and swelling inhibition properties for aqueous ink and solvent ink can be obtained. Moreover the resin composition of the present invention comprises preferably at least an ethylenically unsaturated compound as Component B.

Examples of the ethylenically unsaturated compound, silane compound, polycarboxylic acid compound, polycarboxylic acid halide compound, polyol compound, polyamine compound, polyisocyanate compound, acid anhydride compound, and hydroxycarboxylic acid compound that can be used in Component B include the step-growth polymerizable monomers and chain-growth polymerizable monomers described for Component A.

Among them, as the ethylenically unsaturated compound and the silane compound, the compounds below are preferable.

Furthermore, the polymerizable compound that can be used in the present invention preferably has a molecular weight (or number average molecular weight) of less than 5,000.

The ethylenically unsaturated compound is a compound having one or more ethylenically unsaturated groups. Regarding the ethylenically unsaturated compound, one kind may be used alone, or two or more kinds may be used in combination.

Furthermore, the compound group which belongs to ethylenically unsaturated compounds is widely known in the pertinent industrial fields, and in the present invention, these compounds can be used without particular limitations. These compounds have chemical forms such as, for example, monomer, prepolymer (namely, dimer, trimer and oligomer), or copolymer thereof, and mixture thereof.

As the ethylenically unsaturated compound, a polyfunctional monomer is preferably used. Molecular weights of these polyfunctional monomers are preferably 200 to 2,000.

As the polyfunctional ethylenically unsaturated compound, a compound having 2 to 20 terminal ethylenically unsaturated groups is preferable.

Examples of a compound from which the ethylenically unsaturated group in the polyfunctional ethylenically unsaturated compound is derived include unsaturated carboxylic acids (such as acrylic acid, methacrylic acid, itaconic acid, crotonic acid, isocrotonic acid and maleic acid), and esters and amides thereof. Preferably esters of an unsaturated carboxylic acid and an aliphatic polyhydric alcoholic compound, or amides of an unsaturated carboxylic acid and an aliphatic polyvalent amine compound are used. Moreover, addition reaction products of unsaturated carboxylic acid esters or amides having a nucleophilic substituent such as a hydroxyl group or an amino group with polyfunctional isocyanates or epoxies, and dehydrating condensation reaction products with a polyfunctional carboxylic acid, etc. are also used favorably. Moreover, addition reaction products of unsaturated carboxylic acid esters or amides having an electrophilic substituent such as an isocyanato group or an epoxy group with monofunctional or polyfunctional alcohols or amines, and substitution reaction products of unsaturated carboxylic acid esters or amides having a leaving group such as a halogen atom or a tosyloxy group with monofunctional or polyfunctional alcohols or amines are also favorable. Moreover, as another example, the use of compounds obtained by replacing the unsaturated carboxylic acid with a vinyl compound, an allyl compound, an unsaturated phosphonic acid, styrene or the like is also possible.

The ethylenically unsaturated group which is comprised in the polyfunctional ethylenically unsaturated compound described above is preferably an residue of a (meth)acrylate compound, a vinyl compound, or an aryl compound, and particularly preferably an acrylate compound or a methacrylate compound, from the viewpoint of reactivity. From the viewpoint of printing durability, the polyfunctional ethylenically unsaturated compound more preferably has three or more ethylenically unsaturated groups.

Specific examples of ester monomers of an aliphatic polyhydric alcohol compound and an unsaturated carboxylic acid include acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, and a polyester acrylate oligomer.

Examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane. Among them, trimethylolpropane trimethacrylate is particularly preferable.

As examples of other esters, aliphatic alcohol-based esters described in JP-B-46-27926, JP-B-51-47334 and JP-A-57-196231, those having an aromatic skeleton described in JP-A-59-5240, JP-A-59-5241, and JP-A-2-226149, those having an amino group described in JP-A-1-165613, etc. may also be used preferably.

The ester monomers may be used as a mixture.

Furthermore, specific examples of amide monomers including an amide of an aliphatic polyamine compound and an unsaturated carboxylic acid include N,N′-methylenebisacrylamide, N,N′-methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based monomers include those having a cyclohexylene structure described in JP-B-54-21726.

Furthermore, a urethane-based addition-polymerizable compound produced by an addition reaction of an isocyanate and a hydroxy group is also suitable, and specific examples thereof include a vinylurethane compound comprising two or more polymerizable vinyl groups per molecule in which a hydroxy group-containing vinyl monomer represented by Formula (I) below is added to a polyisocyanate compound having two or more isocyanate groups per molecule described in JP-B-48-41708.

CH₂═C(R)COOCH₂CH(R′)OH (i)

wherein R and R′ independently denote H or CH₃.

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, JP-B-62-39418 are also suitable.

Furthermore, by use of an addition-polymerizable compound having an amino structure or a sulfide structure in the molecule described in JP-A-63-277653, JP-A-63-260909, and JP-A-1-105238, a curing resin composition can be easily obtained.

Other examples include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Among them, the polyfunctional ethylenically unsaturated compound preferably comprises a (meth)acrylate compound, more preferably an alkylenediol di(meth)acrylate, yet more preferably an alkylenediol di(meth)acrylate in which the alkylenediol has 4 to 12 carbons, and particularly preferably 1,6-hexanediol di(meth)acrylate. When in this embodiment, a flexographic printing plate having excellent printing durability and swelling inhibition properties for aqueous ink and solvent ink can be obtained.

Furthermore, Component B preferably comprises a compound comprising at least one type from a hydrolyzable silyl group and a silanol group, and more preferably an ethylenically unsaturated compound and a compound comprising at least one type from a hydrolyzable silyl group and a silanol group. When in this embodiment, a flexographic printing plate having excellent rinsing properties for engraving residue and having excellent printing durability and swelling inhibition properties for aqueous ink and solvent ink can be obtained.

With regard to a compound comprising at least one type from a hydrolyzable silyl group and a silanol group, the ‘hydrolyzable silyl group’ means a silyl group having hydrolyzability. Examples of the hydrolyzable group include an alkoxy group, a mercapto group, a halogen atom, an amide group, an acetoxy group, an amino group, and an isopropenoxy group. A silyl group undergoes hydrolysis to become a silanol group, and a resulting silanol group undergoes dehydration-condensation to form a siloxane bond. Such a hydrolyzable silyl group and/or silanol group is preferably represented by Formula (B-1).

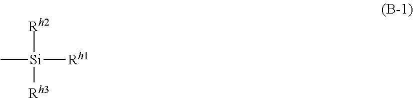

In Formula (B-1) above, at least one of R^{h1} to R^{h3} denotes a hydrolyzable group selected from the group consisting of an alkoxy group, a mercapto group, a halogen atom, an amide group, an acetoxy group, an amino group, and an isopropenoxy group, or a hydroxy group. The remainder of R^{h1} to R^{h3} independently denotes a hydrogen atom, a halogen atom, or a monovalent organic substituent (examples including an alkyl group, an aryl group, an alkenyl group, an alkynyl group, and an aralkyl group).

In Formula (B-1) above, the hydrolyzable group bonded to the silicon atom is particularly preferably an alkoxy group or a halogen atom, and more preferably an alkoxy group.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms, and most preferably a methoxy group or an ethoxy group.

Furthermore, examples of the halogen atom include an F atom, a Cl atom, a Br atom, and an I atom, and from the viewpoint of ease of synthesis and stability it is preferably a Cl atom or a Br atom, and more preferably a Cl atom.

The compound comprising at least one type from a hydrolyzable silyl group and a silanol group in the present invention is preferably a compound having one or more groups represented by Formula (B-1) above, and more preferably a compound having two or more. A compound having two or more hydrolyzable silyl groups is particularly preferably used. That is, a compound having in the molecule two or more silicon atoms having a hydrolyzable group bonded thereto is preferably used. The number of silicon atoms having a hydrolyzable group bond thereto is preferably at least 2 but no greater than 6, and most preferably 2 or 3.

A range of 1 to 4 of the hydrolyzable groups may bond to one silicon atom, and the total number of hydrolyzable groups in Formula (B-1) is preferably in a range of 2 or 3. It is particularly preferable that three hydrolyzable groups are bonded to a silicon atom. When two or more hydrolyzable groups are bonded to a silicon atom, they may be identical to or different from each other.

Specific preferred examples of the alkoxy group include a methoxy group, an ethoxy group, a propoxy group, an isopropoxy group, a butoxy group, a tert-butoxy group, a phenoxy group, and a benzyloxy group. A plurality of each of these alkoxy groups may be used in combination, or a plurality of different alkoxy groups may be used in combination.

Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group.

The compound comprising at least one type from a hydrolyzable silyl group and a silanol group preferably has at least a sulfur atom, an ester bond, a urethane bond, an ether bond, a urea bond, or an imino group.

Among them, from the viewpoint of crosslinkability, the compound comprising at least one type from a hydrolyzable silyl group and a silanol group preferably comprises a sulfur atom, and from the viewpoint of removability (rinsing properties) of engraving residue it is preferable for it to comprise an ester bond, a urethane bond, or an ether bond (in particular, an ether bond contained in an oxyalkylene group), which is easily decomposed by aqueous alkali. A compound comprising at least one type from a hydrolyzable silyl group and a silanol group containing a sulfur atom functions as a vulcanizing agent or a vulcanization accelerator when carrying out a vulcanization treatment, thus promoting a reaction (crosslinking) of a conjugated diene monomer unit-containing polymer. As a result, the rubber elasticity necessary as a printing plate is exhibited. Furthermore, the strength of a crosslinked relief-forming layer and a relief layer is improved.

Furthermore, the compound comprising at least one type from a hydrolyzable silyl group and a silanol group in the present invention is preferably a compound that does not have an ethylenically unsaturated bond.

As the compound comprising at least one type from a hydrolyzable silyl group and a silanol group in the present invention, there can be cited a compound in which a plurality of groups represented by Formula (B-1) above are bonded via a divalent linking group, and from the viewpoint of the effect, such a divalent linking group is preferably a linking group having a sulfide group (—S—), an imino group (—N(R)—) a urea group or a urethane bond (—OCON(R)— or —N(R)COO—). R denotes a hydrogen atom or a substituent. Examples of the substituent denoted by R include an alkyl group, an aryl group, an alkenyl group, an alkynyl group, and an aralkyl group.

A method for synthesizing the compound comprising at least one type from a hydrolyzable silyl group and a silanol group is not particularly limited, and synthesis can be carried out by a known method. Examples of the method include a method described in paragraphs 0019 to 0021 of JP-A-2011-136429.

The compound comprising at least one type from a hydrolyzable silyl group and a silanol group is preferably a compound represented by Formula (B-A-1) or Formula (B-A-2) below.

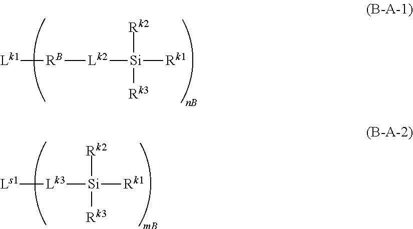

(In Formula (B-A-1) and Formula (B-A-2), R^{B} denotes an ester bond, an amide bond, a urethane bond, a urea bond, or an imino group, L^{k1} denotes an n-valent linking group, L^{k2} denotes a divalent linking group, L^{s1} denotes an m-valent linking group, L^{k3} denotes a divalent linking group, nB and mB independently denote an integer of 1 or greater, and R^{k1} to R^{k3} independently denote a hydrogen atom, a halogen atom, or a monovalent organic substituent. In addition, at least one of R^{k1} to R^{k3} denotes a hydrolyzable group selected from the group consisting of an alkoxy group, a mercapto group, a halogen atom, an amide group, an acetoxy group, an amino group, and an isopropenoxy group, or a hydroxy group.)

R^{k1} to R^{k3} in Formula (B-A-1) and Formula (B-A-2) above have the same meanings as those of R^{h1} to R^{h3} in Formula (B-1) above, and preferred ranges are also the same.

From the viewpoint of rinsing properties and film strength, R^{B} above is preferably an ester bond or a urethane bond, and is more preferably an ester bond.

The divalent or nB-valent linking group denoted by L^{k1} to L^{k3} above is preferably a group formed from at least one type of atom selected from the group consisting of a carbon atom, a hydrogen atom, an oxygen atom, a nitrogen atom, and a sulfur atom, and is more preferably a group formed from at least one type of atom selected from the group consisting of a carbon atom, a hydrogen atom, an oxygen atom, and a sulfur atom. The number of carbon atoms of L^{k1} to L^{k3} above is preferably 2 to 60, and more preferably 2 to 30.

The mB-valent linking group denoted by L^{s} above is preferably a group formed from a sulfur atom and at least one type of atom selected from the group consisting of a carbon atom, a hydrogen atom, an oxygen atom, a nitrogen atom, and a sulfur atom, and is more preferably an alkylene group or a group formed by combining two or more from an alkylene group, a sulfide group, and an imino group. The number of carbon atoms of L^{s1} above is preferably 2 to 60, and more preferably 6 to 30.

nB and mB above are preferably and independently integers of 1 to 10, more preferably integers of 2 to 10, yet more preferably integers of 2 to 6, and particularly preferably 2.

From the viewpoint of removability (rinsing properties) of engraving residue, the nB-valent linking group denoted by L^{k1} and/or the divalent linking group denoted by L^{k2}, or the divalent linking group denoted by L^{k3} preferably has an ether bond, and more preferably has an ether bond contained in an oxyalkylene group.

Among compounds represented by Formula (B-A-1) or Formula (B-A-2), from the viewpoint of crosslinkability, etc., the nB-valent linking group denoted by L^{k1} and/or the divalent linking group denoted by L^{k2} in Formula (B-A-1) are preferably groups having a sulfur atom.

The compound comprising at least one type from a hydrolyzable silyl group and a silanol group is preferably a compound having at least an alkoxy group on the silicon atom of a silyl group, more preferably a compound having two alkoxy groups on the silicon atom of a silyl group, and yet more preferably a compound having three alkoxy group on the silicon atom of a silyl group.

Furthermore, specific examples of the compound comprising at least one type from a hydrolyzable silyl group and a silanol group include compounds described in paragraphs 0025 to 0037 of JP-A-2011-136429.

Among them, the compound comprising at least one type from a hydrolyzable silyl group and a silanol group is preferably a compound having a mercapto group or a sulfide bond, and particularly preferably a compound having a sulfide bond.

Furthermore, the total number of hydrolyzable silyl groups and silanol groups in the compound comprising at least one type from a hydrolyzable silyl group and a silanol group is preferably 1 to 6, more preferably 1 or 2, and particularly preferably 2.

The total content of Component B in the resin composition for laser engraving is preferably 1 to 90 mass % relative to the total solids content, more preferably 10 to 80 mass %, yet more preferably 20 to 75 mass %, and particularly preferably 30 to 70 mass %. When in the above-mentioned range, a relief-forming layer comprising the resin composition for laser engraving has excellent printing durability.

A flexographic printing plate obtained from the resin composition of the present invention has good durability toward both an aqueous ink and a solvent ink. The mechanism of this action is surmised to be as follows.

Chain-growth polymerization of Component B by the use of Component A having a skeleton obtained by step-growth polymerization enables the skeleton obtained by step-growth polymerization and a skeleton obtained by chain-growth polymerization to form, in cooperation, a hard segment and a soft segment. The resin composition of the present invention can give a film having a segment structure that is necessary for tough film strength and high rubber elasticity. It is surmised that because of this a function of suppressing swelling by an aqueous ink and a solvent ink, which is a performance aspect required for flexographic printing, is exhibited, and as a result printing durability toward various types of ink is improved.

It is also surmised that the reason for high engraving sensitivity is that the thermal decomposability of a urethane bond, an ester bond, or an amide bond in the skeleton obtained by step-growth polymerization is high and that thermal decomposition of the skeleton obtained by chain-growth polymerization occurs efficiently in accordance with a depolymerization mechanism.

It is surmised that the reason for high engraving residue rinsing properties is that, as described above, since the thermal decomposability of a resin formed from Component A and Component B is high at the time of laser engraving, an engraving residue component has a low molecular weight, the volatility of the engraving residue increases, and the amount of engraving residue remaining on a printing plate decreases.

### (Component C) Binder Having No Polymerization-Initiating Ability

The resin composition of the present invention for laser engraving preferably comprises, in addition to Components A and B, which are essential components, (Component C) a binder having no polymerization-initiating ability. Component C is a macromolecule that is different from Component A. The macromolecule referred to here means a compound having a number-average molecular weight of at least 5,000. The ‘polymerization-initiating ability’ referred to here means a property of initiating radical polymerization.

Component C may comprises, similarly to Component B, residues having properties of sequential addition-polymerizability (including a radical polymerization) in a narrow sense, as well as residues having properties of poly-condensation or polyaddition.

‘The binder’ means a resin and is preferably non-crystalline resin.

The main chain structure of the binder as Components C is not particularly limited and the binder can be selected from examples such as a polystyrene resin, a polyester resin, a polyamide resin, a polyurea resin, a polyamideimide resin, a polyurethane resin, a polysulfone resin, a polyether sulfone resin, a polyimide resin, a polycarbonate resin, a hydrophilic polymer containing a hydroxyethylene unit, an acrylic resin, an acetal resin, an epoxy resin, a polycarbonate resin and a polysaccharide.

Among them, polyvinyl acetal and a derivative thereof, a polyurethane resin, a polyester resin, a polyester urethane resin, a styrene butadiene resin, polylactic acid, a (meth)acrylic resin, a polycarbonate resin, and a polysaccharide are more preferable, and polyvinyl acetal and a derivative thereof, a polyurethane resin, and a styrene butadiene resin are yet more preferable.

From the viewpoint of forming a relief-forming layer for laser engraving, Component C also preferably has an ethylenically unsaturated group (ethylenically unsaturated bond) and also preferably has a functional group that reacts with a silane coupling agent such as a hydroxy group. Specific examples of the latter include a specific binder that is described later, and a polyurethane resin having a hydroxy group at a molecular terminal. These binders are explained below.

As Component C above, a binder having a hydroxyl group (—OH) (hereinafter, also referred to as the “specific polymer”) is particularly preferable. As the skeleton of the specific binder, although not particularly limited, a (meth)acrylic resin, an epoxy resin, hydrophilic binders containing a hydroxyethylene unit, a polyvinylacetal resin, a polyester resin and a polyurethane resin are preferable.

Examples of the (meth)acrylic monomers used for synthesizing a (meth)acrylic resin having a hydroxyl group include preferably (meth)acrylic acid esters, crotonic acid esters and (meth)acrylamides having a hydroxyl group in the molecule. Specific examples of such monomers include 2-hydroxyethyl(meth)acrylate, 2-hydroxypropyl(meth)acrylate, 4-hydroxybutyl(meth)acrylate etc. Copolymers obtained by copolymerizing these with a known (meth)acrylic-based monomer or vinyl-based monomer are used preferably.

As the specific binder, the use of an epoxy resin having a hydroxyl group on the side chain may also be possible. As a preferable specific example, an epoxy resin obtained by polymerizing an adduct of bisphenol A and epichlorohydrin as raw material monomers is cited.

As the polyester resin, a polyester resin containing a hydroxycarboxylic acid unit such as polylactic acid is preferably used. Specifically, the polyester resin selected from the group consisting of polyhydroxy alkanoate (PHA), lactic acid-based binder, polyglycolic acid (PGA), polycaprolactone (PCL), poly(butylenesuccinic acid), derivatives and mixtures thereof is preferable.

It is also preferable to use a polysaccharide as a specific binder; as the polysaccharide, cellulose and a cellulose derivative are preferably used, and a cellulose derivative is more preferably used.

Normal cellulose is very poorly soluble in water, an alcohol, etc., but modifying a residual OH of a glucopyranose unit with a specific functional group enables water or solvent solubility to be controlled, and a cellulose derivative that has thus been made soluble in an alcohol having 1 to 4 carbons but insoluble in water is also suitable as Component A in the present invention.

Examples of the cellulose derivative include an alkyl cellulose such as ethyl cellulose or methyl cellulose, hydroxyethylene cellulose, hydroxypropylene cellulose, and cellulose acetate butyrate. Furthermore, specific examples thereof include the Metolose series manufactured by Shin-Etsu Chemical Co., Ltd. The contents of this series include those formed by replacing some of the hydrogen atoms of hydroxy groups of cellulose by methyl groups (—CH₃), hydroxypropyl groups (—CH₂CHOHCH₃), or hydroxyethyl groups (—CH₂CH₂OH).

Among them, an alkyl cellulose is preferable, and ethyl cellulose and/or methyl cellulose are more preferable.

Examples of preferable specific binders in the present invention include polyvinyl butyral (PVB), acrylic resin having a hydroxyl group on the side chain, epoxy resin having a hydroxyl group on the side chain etc., from the viewpoint of having high printing durability while satisfying both the aptitude for an aqueous ink and the aptitude for a solvent ink.

Polyvinyl acetal and a derivative thereof, which are other specific examples of Component C that can preferably be used in the present invention, are explained below.

### <Polyvinyl Acetal and Derivative Thereof>

Polyvinyl acetal is a compound obtained by converting polyvinyl alcohol (obtained by saponifying polyvinyl acetate) into a cyclic acetal. A polyvinyl acetal derivative is a polymer that polyvinyl acetal above is modified, or a polyvinyl acetal having another copolymerization component.

The acetal content in the polyvinyl acetal (mole % of vinyl alcohol units converted into acetal with the total number of moles of vinyl acetate monomer starting material as 100%) is preferably 30 to 90%, more preferably 50 to 85%, and particularly preferably 55 to 78%.

The vinyl alcohol unit in the polyvinyl acetal is preferably 10 to 70 mole % relative to the total number of moles of the vinyl acetate monomer starting material, more preferably 15 to 50 mole %, and particularly preferably 22 to 45 mole %.

Furthermore, the polyvinyl acetal may have a vinyl acetate unit as another component, and the content thereof is preferably 0.01 to 20 mole %, and more preferably 0.1 to 10 mole %. The polyvinyl acetal derivative may further have another copolymerization unit.

Examples of the polyvinyl acetal include polyvinyl butyral, polyvinyl propylal, polyvinyl ethylal, and polyvinyl methylal. Among them, polyvinyl butyral derivative (PVB) is preferable.

Polyvinyl butyral is a polymer obtained by a reaction polyvinyl alcohol and butyl aldehyde. A polyvinyl butyral derivative may be used.

Examples of the polyvinyl butyral derivatives include an acid-modified PVB in which at least some of the hydroxy groups of the hydroxyethylene units are modified with an acid group such as a carboxy group, a modified PVB in which some of the hydroxy groups are modified with a (meth)acryloyl group, a modified PVB in which at least some of the hydroxy groups are modified with an amino group, and a modified PVB in which at least some of the hydroxy groups have introduced thereinto ethylene glycol, propylene glycol, or a multimer thereof.

From the viewpoint of a balance being achieved between engraving sensitivity and film formation properties, the molecular weight of the polyvinyl acetal is preferably 5,000 to 800,000 as the weight-average molecular weight, more preferably 8,000 to 500,000 and, from the viewpoint of improvement of rinsing properties for engraving residue, particularly preferably 50,000 to 300,000. The weight-average molecular weight here employs polystyrene conversion by GPC measurement.

Hereinafter, polyvinyl butyral (PVB) and derivatives thereof are cited for explanation as particularly preferable examples of polyvinyl acetal, but are not limited to these.

Polyvinyl butyral has a structure as shown below, and is constituted while including these structural units.

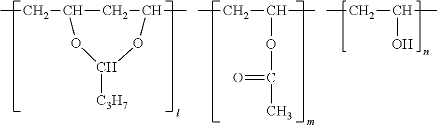

In the above formula, l, m, and n denote the content (mol %) of the respective repeating units in polyvinyl butyral, and the relationship l+m+n=100 is satisfied. The butyral content in the polyvinyl butyral and the derivative thereof (value of l in the formula above) is preferably 30 to 90 mole %, more preferably 40 to 85 mole %, and particularly preferably 45 to 78 mole %.

From the viewpoint of a balance being achieved between printing durability and ink adhering properties, the weight-average molecular weight of the polyvinyl butyral and the derivative thereof is preferably 5,000 to 800,000, more preferably 8,000 to 500,000.

The PVB derivative is also available as a commercial product, and preferred examples thereof include, from the viewpoint of alcohol dissolving capability (particularly, ethanol), “S-REC B” series and “S-REC K (KS)” series manufactured by SEKISUI CHEMICAL CO., LTD. and “DENKA BUTYRAL” manufactured by DENKI KAGAKU KOGYO KABUSHIKI KAISHA. From the viewpoint of alcohol dissolving capability (particularly, ethanol), “S-REC B” series manufactured by SEKISUI CHEMICAL CO., LTD. and “DENKA BUTYRAL” manufactured by DENKI KAGAKU KOGYO KABUSHIKI KAISHA are more preferable. Among these, particularly preferable commercial products are shown below along with the values I, m, and n in the above formulae and the molecular weight. Examples of “S-REC B” series manufactured by SEKISUI CHEMICAL CO., LTD. include “BL-1” (l=61, m=3, n=36, weight-average molecular weight: 19,000), “BL-1H” (l=67, m=3, n=30, weight-average molecular weight: 20,000), “BL-2” (l=61, m=3, n=36, weight-average molecular weight: about 27,000), “BL-5” (l=75, m=4, n=21, weight-average molecular weight: 32,000), “BL-S” (l=74, m=4, n=22, weight-average molecular weight: 23,000), “BM-S” (l=73, m=5, n=22, weight-average molecular weight: 53,000), and “BH-S” (l=73, m=5, n=22, weight-average molecular weight: 66,000), and examples of “DENKA BUTYRAL” manufactured by DENKI KAGAKU KOGYO include “#3000-1” (l=71, m=1, n=28, weight-average molecular weight: 74,000), “#3000-2” (l=71, m=1, n=28, weight-average molecular weight: 90,000), “#3000-4” (l=71, m=1, n=28, weight-average molecular weight: 117,000), “#4000-2” (l=71, m=1, n=28, weight-average molecular weight: 152,000), “#6000-C” (l=64, m=1, n=35, weight-average molecular weight: 308,000), “#6000-EP” (l=56, m=15, n=29, weight-average molecular weight: 381,000), “#6000-CS” (l=74, m=1, n=25, weight-average molecular weight: 322,000), and “#6000-AS” (l=73, m=1, n=26, weight-average molecular weight: 242,000). Also preferable is Mowital series of KURARAY CO., LTD. such as “B 16 H” (m=1 to 4, n=18 to 24), “B 20 H” (m=1 to 4, n=18 to 21), “B 30 T” (m=1 to 4, n=24 to 27), “B 30 H” (m=1 to 4, n=18 to 21), “B 30 HH” (m=1 to 4, n=11 to 14), “B 45 M” (m=1 to 4, n=21 to 24), “B 45 H” (m=1 to 4, n=18 to 21), “B 60 T” (m=1 to 4, n=24 to 27), “B 60 H” (m=1 to 4, n=18 to 21), “B 60 HH” (m=1 to 4, n=12 to 16) and “B 75 H” (m=1 to 4, n=18 to 21)

When the relief-forming layer is formed using the PVB derivative as a specific binder, a method of casting and drying a solution in which the binder is dissolved in a solvent is preferable from the viewpoint of smoothness of the film surface.

### <Acrylic Resin>

As an acrylic resin usable as a specific binder, an acrylic resin may be used which can be synthesized from an acrylic monomer having a hydroxy group in the monomer.

Preferable examples of the acrylic monomer used for producing an acrylic resin having a hydroxy group include a (meth)acrylic acid ester, a crotonic acid ester, or a (meth)acrylamide that has a hydroxy group in the molecule. Specific examples of such a monomer include 2-hydroxyethyl(meth)acrylate, 2-hydroxypropyl(meth)acrylate, and 4-hydroxybutyl(meth)acrylate.

In the present invention ‘(meth)acryl’ means ‘acryl’ and/or ‘methacryl’ and ‘(meth)acrylate’ means ‘acrylate’ and/or ‘methacrylate.’

Among the specific binders, polyvinyl butyral and derivatives thereof are particularly preferable from the viewpoint of printing durability when made into a thermally cured layer.

The content of a hydroxyl group contained in the specific binder in the present invention is preferably 0.1 to 15 mmol/g, and more preferably 0.5 to 7 mmol/g, in the binder of any embodiment described above.

### <Urethane(Meth)Acrylate>

A urethane(meth)acrylate is another specific example of a binder that can preferably be used as Component C in the present invention.

The urethane(meth)acrylate is for example derived from a polyurethane resin having a hydroxy group at a molecular terminal or in a molecular main chain.

The polyurethane resin having a hydroxy group at a molecular terminal as a starting material may be formed by reacting at least one type of polyisocyanate and at least one type of polyhydric alcohol component.

The polyurethane resin having a hydroxyl group at a molecular terminal preferably further has at least one bond selected from a carbonate bond and an ester bond in the molecule. When the polyurethane resin has the bonds described above, the resistance of a printing plate to an ink cleaning agent containing an ester-based solvent or an ink cleaning agent containing a hydrocarbon-based solvent, which are used in printing, tends to improve, which is preferable.

The method for producing a polyurethane resin having a hydroxyl group at a molecular terminal is not particularly limited, and for example, a method of allowing a compound having a carbonate bond or an ester bond, and having plural reactive groups such as a hydroxyl group, an amino group, an epoxy group, a carboxyl group, an acid anhydride group, a ketone group, a hydrazine residue, an isocyanate group, an isothiocyanate group, a cyclic carbonate group, or an alkoxycarbonyl group, with a molecular weight of about several thousands, to react with a compound having plural functional groups that are capable of bonding with the reactive groups (for example, a polyisocyanate having a hydroxyl group, an amino group or the like), and performing regulation of the molecular weight and conversion of the molecular terminal to bondable groups, and the like can be used.

Examples of the diol compound having a carbonate bond, which is used in the production of a polyurethane resin having a hydroxyl group at a molecular terminal, include aliphatic polycarbonate diols such as 4,6-polyalkylene carbonate diol, 8,9-polyalkylene carbonate diol, and 5,6-polyalkylene carbonate diol. Furthermore, an aliphatic polycarbonate diol having an aromatic molecular structure in the molecule may also be used. When the hydroxyl groups at the terminal of these compounds are subjected to a condensation reaction with a diisocyanate compound such as tolylene diisocyanate, diphenylmethane diisocyanate, hexamethylene diisocyanate, isophorone diisocyanate, dicyclohexylmethane diisocyanate, tetramethylxylene diisocyanate, xylene diisocyanate, naphthalene diisocyanate, trimethylhexamethylene diisocyanate, p-phenylene diisocyanate, cyclohexylene diisocyanate, lysine diisocyanate, or triphenylmethane diisocyanate; or a triisocyanate compound such as triphenylmethane triisocyanate, 1-methylbenzene-2,4,6-triisocyanate, naphthalene-1,3,7-triisocyanate, or biphenyl-2,4,4′-triisocyanate, a urethane bond can be introduced to the compounds.

Examples of commercially available urethane(meth)acrylates, etc. include UV-3200, UV-3000B, UV-3700B, UV-3210EA, and UV-2000B of the Shikoh (registered trademark) series (all manufactured by The Nippon Synthetic Chemical Industry Co., Ltd.), EBECRYL 230 and EBECRYL 9227EA (both manufactured by Daicel-Cytec Company Ltd.), and AU-3040, AU-3050, AU-3090, AU-3110, and AU-3120 of the Hi-Coap AU (registered trademark) series (all manufactured by Tokushiki Co., Ltd.).

As another method for obtaining a urethane(meth)acrylate, etc., there is a method in which a polyurethane is formed by a polyaddition reaction between the polyisocyanate compound and a diol compound having a (meth)acryloyloxy group.

Preferred examples of the diol compound having a (meth)acryloyloxy group used in this case include Blemmer GLM manufactured by NOF Corporation and DA-212, DA-250, DA-721, DA-722, DA-911M, DA-920, DA-931, DM-201, DM-811, DM-832, and DM-851 of the ‘Denacol Acrylate (registered trademark)’ series manufactured by Nagase ChemteX Corporation.

### <Styrene Butadiene Rubber>

From the viewpoint of use for the purpose of improving strength by crosslinking the resin composition for laser engraving by heating or exposure to light, a polymer having an ethylenically unsaturated bond in the molecule is preferably used as Component C.

Such a polymer includes so-called styrene butadiene rubber (SBR); in more detail, examples of polymers having an ethylenically unsaturated bond in a main chain include SB (polystyrene-polybutadiene), SBS (polystyrene-polybutadiene-polystyrene), SIS (polystyrene-polyisoprene-polystyrene), and SEBS (polystyrene-polyethylene/polybutylene-polystyrene).

A polymer having an ethylenically unsaturated bond in a side chain is obtained by introducing an ethylenically unsaturated bond such as an allyl group, an acryloyl group, a methacryloyl group, a styryl group, or a vinyl ether group into a side chain of a skeleton of a binder polymer, which is described later. As a method for introducing an ethylenically unsaturated bond into a binder polymer side chain, a known method may be used such as (1) a method in which a structural unit having a polymerizable group precursor formed by bonding a protecting group to a polymerizable group is copolymerized with a polymer, and the polymerizable group is formed by removing the protecting group or (2) a method in which a macromolecular compound having a plurality of reactive groups such as hydroxy groups, amino groups, epoxy groups, or carboxyl groups is produced and a compound having an ethylenically unsaturated bond and a group that reacts with the above reactive groups is introduced by a polymer reaction. In accordance with these methods, the amount of ethylenically unsaturated groups introduced into the macromolecule compound can be controlled.

As the styrene butadiene rubber, a commercial product available from JSR, etc. may be used.

It is preferable to use as Component C a binder having a glass transition temperature (Tg) of 25° C. or higher (hereinafter, also called ‘(Component C1)’.

In the present invention, the relief-forming layer preferably comprises (Component C1) a binder having a glass transition temperature (Tg) of 25° C. or higher. When Component C1 has a plurality of Tgs such as it being a block copolymer, the highest Tg of Component C1 is 25° C. or higher and a Tg on the low temperature side may be lower than 25° C.

The upper limit for the glass transition temperature of Component C1 is not particularly limited, but it is preferably no greater than 200° C. That is, the glass transition temperature of Component A is preferably 25° C. to 200° C., more preferably 30° C. to 150° C., and yet more preferably 40° C. to 120° C.

When a binder having a glass transition temperature of room temperature (25° C.) or greater is used, the specific binder is partially in a glass state at normal temperature. Because of this, compared with a case of a rubber state, thermal molecular motion is suppressed.

Component C1 may be a binder having a plurality of glass transition temperatures, but preferably has one to three glass transition temperatures, more preferably one or two glass transition temperatures, and yet more preferably one glass transition temperature.

With regard to Component C, only one type may be used or two or more types may be used in combination.

The weight-average molecular weight (polystyrene basis by GPC measurement) of Component C that can be used in the present invention is preferably 5,000 to 1,000,000, more preferably 8,000 to 750,000, and most preferably 10,000 to 500,000.

The content of Component C in the resin composition that can be used in the present invention is preferably 2 to 95 mass % relative to the total solids content from the viewpoint of achieving a good balance between coated film shape retention and developability, more preferably 10 to 92 mass %, and yet more preferably 30 to 90 mass %.

It is preferable for the content of Component C to be in this range since a printing plate obtained from the composition for laser engraving has excellent printing durability.

Examples of the binder other than above-mentioned binders include non-elastomers described in JP-A-2011-136455, and the unsaturated group-containing polymers described in JP-A-2010-208326.

The content of Component C in the resin composition for laser engraving is preferably 5 to 80 mass % relative to the total solids content, more preferably 10 to 70 mass %, yet more preferably 20 to 70 mass %, and particularly preferably 30 to 60 mass %. When in this range, a relief-forming layer formed from the resin composition for laser engraving has excellent printing durability.

### (Component D) Photothermal Conversion Agent

The resin composition for laser engraving of the present invention preferably further includes (Component C) a photothermal conversion agent. That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for graving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the flexographic printing plate precursor for laser engraving which is produced by using the resin composition for laser engraving of the present invention to comprise a photothermal conversion agent that has a maximum absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, and preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples of pigments include pigments described in paragraphs 0122 to 0125 of JP-A-2009-178869.

Among these pigments, carbon black is preferable.

Any carbon black, regardless of classification by ASTM (American Society for Testing and Materials) and application (e.g. for coloring, for rubber, for dry cell, etc.), may be used as long as dispersibility, etc. in the resin composition for laser engraving is stable. Examples of the carbon black include furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples of carbon black include carbon blacks described in paragraphs 0130 to 0134 of JP-A-2009-178869.

The photothermal conversion agent in the resin composition of the present invention may be used singly or in a combination of two or more compounds.

The content of the photothermal conversion agent in the resin composition for laser engraving of the present invention may vary greatly with the magnitude of the molecular extinction coefficient inherent to the molecule, but the content is preferably 0.01 to 30 mass %, more preferably 0.05 to 20 mass %, and particularly preferably 0.1 to 10 mass %, relative to the total mass of the above resin composition.

Various components usable in the resin composition of the present invention other than Component A to Component D are now explained below.

### <Plasticizer>

The resin composition for laser engraving of the present invention may comprise a plasticizer.

A plasticizer has the function of softening a film formed from the resin composition for laser engraving, and it is necessary for it to be compatible with a binder polymer.

Preferred examples of the plasticizer include dioctyl phthalate, didodecyl phthalate, bisbutoxyethyl adipate, a polyethylene glycol, and a polypropylene glycol (monool type or diol type).

Among them, bisbutoxyethyl adipate is particularly preferable.

With regard to plasticizer in the resin composition of the present invention, one type thereof may be used on its own or two or more types may be used in combination.

### <Solvent>

It is preferably to use a solvent when preparing the resin composition for laser engraving of the present invention.

As the solvent, an organic solvent is preferably used.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among these, propylene glycol monomethyl ether acetate is preferable.

### <Other Additives>

The resin composition for laser engraving of the present invention may comprise as appropriate various types of known additives as long as the effects of the present invention are not inhibited. Examples include a filler, a wax, a process oil, a metal oxide, an antiozonant, an anti-aging agent, a polymerization inhibitor, and a colorant, and one type thereof may be used on its own or two more types may be used in combination

As the filler, inorganic particles can be cited and silica particles are preferably cited.

The inorganic particles preferably have a number-average particle size of at least 0.01 μm but no greater than 10 μm. Furthermore, the inorganic particles are preferably porous particles or nonporous particles.

The porous particles referred to here are defined as particles having fine pores having a pore volume of at least 0.1 mL/g in the particle or particles having fine cavities.

The porous particles preferably have a specific surface area of at least 10 m²/g but no greater than 1,500 m²/g, an average pore diameter of at least 1 nm but no greater than 1,000 nm, a pore volume of at least 0.1 mL/g but no greater than 10 mL/g, and an oil adsorption of at least 10 mL/100 g but no greater than 2,000 mL/100 g. The specific surface area is determined based on the BET equation from the adsorption isotherm of nitrogen at −196° C. Furthermore, measurement of the pore volume and the average pore diameter preferably employs a nitrogen adsorption method. Measurement of the oil adsorption may be suitably carried out in accordance with JIS-K5101.

The number-average particle size of the porous particles is preferably at least 0.01 μm but no greater than 10 μm, more preferably at least 0.5 μm but no greater than 8 μm, and yet more preferably at least 1 μm but no greater than 5 μm.

The shape of the porous particles is not particularly limited, and spherical, flat-shaped, needle-shaped, or amorphous particles, or particles having projections on the surface, etc. may be used.

Furthermore, particles having a cavity in the interior, spherical granules having a uniform pore diameter such as a silica sponge, etc. may be used. Examples thereof are not particularly limited but include porous silica, mesoporous silica, a silica-zirconia porous gel, porous alumina, and a porous glass. Furthermore, as for a layered clay compound, pore diameter cannot be defined for those having a cavity of a few nm to a few hundred nm between layers, and in the present embodiment the distance between cavities present between layers is defined as the pore diameter.

Moreover, particles obtained by subjecting the surface of porous particles to a surface modifying treatment by covering with a silane coupling agent, a titanium coupling agent, or another organic compound so as to make the surface hydrophilic or hydrophobic may also be used. With regard to these porous particles, one type or two or more types may be selected.

The nonporous particles above are defined as particles having a pore volume of less than 0.1 mL/g. The number-average particle size of the nonporous particles is the number-average particle size for primary particles as the target, and is preferably at least 10 nm but no greater than 500 nm, and more preferably at least 10 nm but no greater than 100 nm.

The amount of filler added is not particularly limited, but is preferably 1 to 100 parts by mass relative to 100 parts by mass of Component A.

### (Flexographic Printing Plate Precursor for Laser Engraving)

In the present invention, with regard to explanation of the flexographic printing plate precursor, an uncrosslinked layer formed from the resin composition for laser engraving comprising as essential components Component A and Component B is called a ‘relief-forming layer’, a layer formed by crosslinking the relief-forming layer is called a ‘crosslinked relief-forming layer’, and a layer formed by laser-engraving this to form asperities on the surface is called a ‘relief layer’.

A first embodiment of the flexographic printing plate precursor for laser engraving of the present invention comprises a relief-forming layer formed from the resin composition for laser engraving of the present invention.

A second embodiment of the flexographic printing plate precursor for laser engraving of the present invention comprises a crosslinked relief-forming layer formed by crosslinking a relief-forming layer formed from the resin composition for laser engraving of the present invention.

In the present invention, the ‘flexographic printing plate precursor for laser engraving’ means both or one of a flexographic printing plate precursor having a crosslinkable relief-forming layer formed from the resin composition for laser engraving in a state before being crosslinked and a flexographic printing plate precursor in a state in which it is cured by light or heat.

The flexographic printing plate precursor for laser engraving of the present invention is a flexographic printing plate precursor having a crosslinkable relief-forming layer cured by heat.

In the present invention, the ‘relief-forming layer’ means a layer in a state before being crosslinked, that is, a layer formed from the resin composition for laser engraving of the present invention, which may be dried as necessary.

In the present invention, the “crosslinked relief-forming layer” refers to a layer obtained by crosslinking the aforementioned relief-forming layer. The crosslinking can be performed by light and/or heat, and the crosslinking by heat is preferable. Moreover, the above crosslinking is not particularly limited only if it is a reaction that cures the resin composition, and is a general idea that includes the crosslinked structure by the reaction of Component B with each other, and the reaction of Component B with other component such as Component B. When a polymerizable compound is used, the crosslinking includes a crosslinking by polymerization of polymerizable compounds.

The ‘flexographic printing plate’ is made by laser engraving the flexographic printing plate precursor having the crosslinked relief-forming layer.

Moreover, in the present invention, the ‘relief layer’ means a layer of the flexographic printing plate formed by engraving using a laser, that is, the crosslinked relief-forming layer after above laser engraving.

A flexographic printing plate precursor for laser engraving of the present invention comprises a relief-forming layer formed from the resin composition for laser engraving of the present invention, which has the above-mentioned components. The relief-forming layer is preferably provided above a support.

The flexographic printing plate precursor for laser engraving may further comprise, as necessary, an adhesive layer between the support and the relief-forming layer and, above the relief-forming layer, a slip coat layer and a protection film.

### <Relief-Forming Layer>

The relief-forming layer is a layer formed from the resin composition for laser engraving of the present invention, and is preferably crosslinkable by heat.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate producing or printing or may be placed and immobilized thereon, and a support is not always required.

A case in which the relief-forming layer is mainly formed in a sheet shape is explained as an example below.

### <Support>

A material used for the support of the flexographic printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET), polybutylene terephthalate (PBT), or polyacrylonitrile (PAN)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Flexographic Printing Plate Precursor for Laser Engraving)

The process for producing a flexographic printing plate precursor for laser engraving is not particularly limited, and examples thereof include a method in which a resin composition for laser engraving is prepared, solvent is removed from this coating solution composition for laser engraving, and it is then melt-extruded onto a support. Alternatively, a method may be employed in which a resin composition for laser engraving is cast onto a support, and this is dried in an oven to thus remove solvent from the resin composition.

Among them, the process for producing a flexographic printing plate precursor for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a flexographic printing plate precursor having a crosslinked relief-forming layer, and more preferably a production process comprising a layer formation step of forming a relief-forming layer from the resin composition for laser engraving of the present invention and a crosslinking step of crosslinking the relief-forming layer by means of heat to thus obtain a flexographic printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for producing the flexographic printing plate precursor for laser engraving of the present invention preferably comprises a layer formation step of forming a relief-forming layer from the resin composition for laser engraving of the present invention.

Preferred examples of a method for forming the relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove solvent.

The resin composition for laser engraving may be produced by, for example, dissolving or dispersing Components A to C, and optional components J in an appropriate solvent, and then dissolving or dispersing.

The thickness of the relief-forming layer in the flexographic printing plate precursor for laser engraving is preferably 0.05 to 10 mm before and after crosslinking, more preferably 0.05 to 7 mm, and yet more preferably 0.05 to 3 mm.

### <Crosslinking Step>

The process for producing a flexographic printing plate precursor for laser engraving of the present invention is preferably a production process comprising a crosslinking step of crosslinking the relief-forming layer by means of heat to thus obtain a flexographic printing plate precursor having a crosslinked relief-forming layer.

When the relief-forming layer comprises a photopolymerization initiator, the relief-forming layer may be crosslinked by irradiating the relief-forming layer with actinic radiation that triggers the photopolymerization initiator.

It is preferable to apply light to the entire surface of the relief-forming layer. Examples of the light (also called ‘actinic radiation’) include visible light, UV light, and an electron beam, but UV light is most preferably used. When the side where there is a substrate, such as a relief-forming layer support, for fixing the relief-forming layer, is defined as the reverse face, only the front face need to be irradiated with light, but when the support is a transparent film through which actinic radiation passes, it is preferable to further irradiate from the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

When the relief-forming layer comprises thermal polymerization initiator (the photopolymerization initiator can also be a thermal polymerization initiator.), the relief-forming layer may be crosslinked by heating the flexographic printing plate precursor for laser engraving (step of crosslinking by means of heat). As heating means for carrying out crosslinking by heat, there can be cited a method in which a printing plate precursor is heated in a hot air oven or a far-infrared oven for a predetermined period of time and a method in which it is put into contact with a heated roller for a predetermined period of time.

As a method for crosslinking the relief-forming layer, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, tackiness of engraving residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases. Furthermore, in terms of general properties of a material, the lower the molecular weight, the more easily it becomes a liquid than a solid, that is, there is a tendency for tackiness to increase. Engraving residue formed when engraving a relief-forming layer tends to have higher tackiness as larger amounts of low-molecular-weight materials are used. Since a polymerizable compound, which is a low-molecular-weight material, becomes a polymer by crosslinking, the tackiness of the engraving residue formed tends to decrease.

When the crosslinking step is a step of carrying out crosslinking by light, although equipment for applying actinic radiation is relatively expensive, since a printing plate precursor does not reach a high temperature, there are hardly any restrictions on starting materials for the printing plate precursor.

When the crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

During thermal crosslinking, it is preferable to add a thermopolymerization initiator. As the thermopolymerization initiator, a commercial thermopolymerization initiator for free radical polymerization may be used. Examples of such a thermopolymerization initiator include an appropriate peroxide, hydroperoxide, and azo group-containing compound. A representative vulcanizing agent may also be used for crosslinking. Thermal crosslinking may also be carried out by adding a heat-curable resin such as for example an epoxy resin as a crosslinking component to a layer.

(Flexographic Printing Plate and Process for Making Same)

The process for making a flexographic printing plate of the present invention preferably comprises a laser engraving step of laser-engraving a flexographic printing plate precursor comprising a crosslinked relief-forming layer produced by crosslinking by means of heat and/or light the resin composition for laser engraving of the present invention, and preferably comprises a laser engraving step of laser-engraving a flexographic printing plate precursor comprising a crosslinked relief-forming layer produced by crosslinking by means of heat the resin composition for laser engraving of the present invention

The flexographic printing plate of the present invention is a flexographic printing plate having a relief forming layer obtained by laser-engraving a layer formed from the crosslinked resin composition for laser engraving of the present invention, and is preferably a flexographic printing plate made by the process for producing a flexographic printing plate of the present invention.

The flexographic printing plate of the present invention may suitably employ an aqueous ink when printing.

The layer formation step and the crosslinking step in the process for producing a flexographic printing plate of the present invention mean the same as the layer formation step and the crosslinking step in the above-mentioned process for producing a flexographic printing plate precursor for laser engraving, and preferred ranges are also the same.

### <Engraving Step>

The process for producing a flexographic printing plate of the present invention preferably comprises an engraving step of laser-engraving the flexographic printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser (an IR laser), molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate making equipment comprising a fiber-coupled semiconductor laser that can be used suitably in the process for making a flexographic printing plate employing the flexographic printing plate precursor of the present invention, those described in detail in JP-A-2009-172658 and JP-A-2009-214334 can be cited. Such equipment comprising a fiber-coupled semiconductor laser can be used to produce a flexographic printing plate of the present invention.

The process for producing a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraved residue is attached to the engraved surface, a rinsing step of washing off engraved residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraved residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.2, and especially preferably no greater than 13.1. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraved residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

The flexographic printing plate of the present invention having a relief layer above the surface of an optional substrate such as a support may be produced as described above.

From the viewpoint of satisfying suitability for various aspects of printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The flexographic printing plate of the present invention is particularly suitable for printing by a flexographic printer using an aqueous ink, but printing is also possible when it is carried out by a letterpress printer using any of aqueous, oil-based, and UV inks, and printing is also possible when it is carried out by a flexographic printer using a UV ink. The flexographic printing plate of the present invention has excellent rinsing properties, there is no engraved residue, and has excellent printing durability, and printing can be carried out for a long period of time without plastic deformation of the relief layer or degradation of printing durability.

In accordance with the present invention, there can be provided a resin composition for laser engraving that can give a flexographic printing plate having good durability toward both an aqueous ink and a solvent ink, a flexographic printing plate precursor employing the resin composition for laser engraving and a process for producing same, a process for making a flexographic printing plate employing same, and a flexographic printing plate obtained thereby.

In accordance with the present invention, there can also be provided a resin composition for laser engraving that can give a flexographic printing plate having good rinsing properties for engraving residue and excellent engraving sensitivity, a flexographic printing plate precursor employing the resin composition for laser engraving and a process for producing same, a process for making a flexographic printing plate employing same, and a flexographic printing plate obtained thereby.

### EXAMPLES

The present invention is explained in further detail below by reference to Examples, but the present invention should not be construed as being limited to these Examples. Furthermore, ‘parts’ in the description below means ‘parts by mass’, and ‘%’ means ‘% by mass’, unless otherwise specified.

Moreover, the number-average molecular weight (Mn) of a polymer in the Examples are values measured by a GPC method unless otherwise specified.

### Example 1

### 1. Preparation of Resin Composition for Laser Engraving

A three-necked flask equipped with a stirring blade and a condenser was charged with 50 parts of UV-3000B (urethane acrylate resin, The Nippon Synthetic Chemical Industry Co., Ltd., Tg: about 36° C.) as Component C and 47 parts of propylene glycol monomethyl ether acetate as a solvent, and heated at 70° C. for 120 min. while stirring, thus dissolving the polymer. Subsequently, the solution was set at 50° C., 25 parts of 1,6-hexanediol diacrylate as the polymerizable compound (Component B) and 20 parts of MI-1 (VPS-1001, Wako Pure Chemical Industries, Ltd.) as the macroinitiator (Component A) were added, and stirring was carried out for 30 min. This operation gave flowable coating solution 1 for a crosslinkable relief-forming layer (resin composition 1 for laser engraving).

### 2. Preparation of Flexographic Printing Plate Precursor for Laser Engraving

A spacer (frame) having a predetermined thickness was placed on a PET substrate, and coating solution 1 for a crosslinkable relief-forming layer obtained above was cast gently so that it did not overflow from the spacer (frame) and dried in an oven at 70° C. for 3 hours. Subsequently, heating was carried out at 80° C. for 3 hours and at 100° C. for a further 3 hours to thus thermally crosslink the relief-forming layer to provide a relief-forming layer having a thickness of about 1 mm, thus preparing flexographic printing plate precursor 1 for laser engraving.

### 3. Making Flexographic Printing Plate

The relief-forming layer after crosslinking (crosslinked relief-forming layer) was engraved using the two types of laser below.

As a carbon dioxide laser engraving machine, for engraving by irradiation with a laser, an ML-9100 series high quality CO₂ laser marker (Keyence) was used. A 1 cm square solid printed part was raster-engraved using the carbon dioxide laser engraving machine under conditions of an output of 12 W, a head speed of 200 mm/sec, and a pitch setting of 2,400 DPI, thus forming halftone dots with a highlight of 1% to 10%.

As a semiconductor laser engraving machine, laser recording equipment provided with an SDL-6390 fiber-coupled semiconductor laser (FC-LD) (JDSU, wavelength 915 nm) with a maximum power of 8.0 W was used. A 1 cm square solid printed part was raster-engraved using the semiconductor laser engraving machine under conditions of a laser output of 7.5 W, a head speed of 409 mm/sec, and a pitch setting of 2,400 DPI, thus forming halftone dots with a highlight of 1% to 10%.

The thickness of the relief layer of the flexographic printing plate thus obtained was about 1 mm.

Furthermore, the Shore A hardness value of the relief layer was 75° according to the aforementioned measurement method.

### Examples 2 to 18 and Comparative Examples 1 to 6

### 1. Preparation of Crosslinkable Resin Compositions for Laser Engraving

Coating solutions 2 to 18 for a crosslinkable relief-forming layer (resin compositions for laser engraving) and comparative coating solutions 1 to 6 for a crosslinkable relief-forming layer (resin compositions for laser engraving) were prepared in the same manner as Example 1 except that Component A to Component D used in Example 1 were changed as described in Table 1 below.

In addition, in each of the Examples and Comparative Examples, 1 part of Ketjen Black EC600JD (carbon black, Lion Corporation) was used as the photothermal conversion agent (Component D).

In Examples 9 to 11, when two types of compounds were used in combination as Component B, the total amount of Component B added was not changed from the amount added in Example 1, and the two types of compounds were added at a mass ratio of 1:1. Specifically, for example, in Example 8, as Component B 12.5 parts of 1,6-hexanediol diacrylate and 12.5 parts of B-1, which is described later, were added.

In Comparative Examples 1 to 5, 0.5 parts of a (low molecular weight) initiator was added.

### 2. Preparation of Flexographic Printing Plate Precursor for Laser Engraving

Flexographic printing plate precursors 2 to 18 for laser engraving of Examples and flexographic printing plate precursors 1 to 6 for laser engraving of Comparative Examples were prepared in the same manner as in Example 1 except that coating solution 1 for a crosslinkable relief-forming layer in Example 1 was changed to coating solutions 2 to 18 for a crosslinkable relief-forming layer and comparative coating solutions 1 to 6 for a crosslinkable relief-forming layer.

### 3. Preparation of Flexographic Printing Plate

Flexographic printing plates 2 to 18 of Examples and flexographic printing plates 1 to 6 of Comparative Example were obtained by subjecting the relief-forming layers of flexographic printing plate precursors 2 to 18 for laser engraving of the Examples and flexographic printing plate precursors 1 to 6 for laser engraving of the Comparative Examples to thermal crosslinking and then engraving to form a relief layer as in Example 1.

The thickness of the relief layers of these flexographic printing plates was about 1 mm.

Furthermore, the Shore A hardness values of the relief layers were 75° according to the aforementioned measurement method.

### 4. Evaluation of Flexographic Printing Plate

Evaluation of the performance of the flexographic printing plates was carried out in terms of the items below, and the results are shown in Table 1. The evaluation results when engraving was carried out using a carbon dioxide laser and the evaluation results when engraving was carried out using a semiconductor laser were the same except the performance of engraving depth.

### (1) Swelling Ratio

A film was cut into a size of 1 cm×1 cm square, immersed in an ink, and allowed to stand at room temperature (25° C.) for 24 hours. Swelling ratio was calculated from the equation below using the mass before immersion and the mass after immersion. As the ink an aqueous ink (Aqua SPZ16 Red, Toyo Ink Manufacturing Co., Ltd.) was used without dilution or a solvent ink (XS-716 507 Blue, DIC GRAPHICS CORPORATION) was used.

Swelling ratio is an indicator in which the smaller the swelling ratio, the greater the resistance to swelling, and in the present invention the closer it is to 100% the better.

Swelling ratio (%)=(weight after ink immersion÷weight before ink immersion)×100

### (2) Printing Durability

A flexographic printing plate that had been obtained was set in a printer (Model ITM-4, IYO KIKAI SEISAKUSHO Co., Ltd.). As the ink, either an aqueous ink (Aqua SPZ16 Red aqueous ink produced by Toyo Ink Manufacturing Co., Ltd.) was used without dilution or a solvent ink (XS-706 507 Primary Color Indigo produced by DIC Graphics Co., Ltd.) was used. Printing was carried out continuously using Full Color Form M 70 (Nippon Paper Industries Co., Ltd., thickness 100 μm) as the printing paper, and a highlight of 1% to 10% was confirmed for a printed material. The end of printing was defined when there was a halftone dot that was not printed, and the length (meters) of paper that was printed up to the end of printing was used as an index. The larger the value, the better the printing durability.

### (3) Engraving Depth

The relief-forming layer of the relief printing plate precursor obtained was laser-engraved by means of a carbon dioxide laser or a semiconductor laser (IR laser), and the ‘engraving depth’ of a relief layer so obtained was measured as follows. The ‘engraving depth’ referred to here means the difference between an engraved position (height) and an unengraved position (height) when a cross-section of the relief layer was examined. The ‘engraving depth’ in the present Examples was measured by examining a cross-section of a relief layer using a VK9510 ultradepth color 3D profile measurement microscope (Keyence Corporation). A large engraving depth means a high engraving sensitivity. The results are given in Table 1 for each of the types of laser used for engraving.

### (4) Rinsing Properties

A laser-engraved flexographic printing plate was immersed in water and an engraved part was rubbed with a toothbrush (Clinica Toothbrush Flat, Lion Corporation) 10 times. Subsequently, the presence/absence of residue on the surface of the relief layer was checked by an optical microscope. When there was no residue, the evaluation was A, when there was hardly any residue the evaluation was B, when there was some residue remaining but there was no practical problem the evaluation was C, and when the residue could not be removed the evaluation was D.

TABLE 1

| | Engraving layer components | | | | | | | | | | |
|---|---|---|---|---|---|---|---|---|---|---|---|
| | | | | (Comp. D) | | | | | | | |
| | | (Comp. B) | | photo- | | | | | | | |
| | (Comp. A) | polymeri- | | thermal | Swelling ratio | | Printing durability | | Engraving depth | | Rinsing |
| | macro- | zable | (Comp. C) | convn. | Aq. | Solvent | Aq. | Solvent | CO₂ | IR laser | prop- |
| | initiator | compd. | binder | agent | ink | ink | ink | ink | laser | (FC-LD) | erties |
| Ex. 1 | MI-1 | 1,6-HDDA | UV-3000B | None | 115 | 140 | 45 km | 20 km | 300 μm | 0 μm | B |
| Ex. 2 | MI-1 | 1,6-HDDA | UV-3000B | CB | 110 | 125 | 60 km | 30 km | 300 μm | 340 μm | B |
| Ex. 3 | MI-2 | 1,6-HDDA | UV-3000B | CB | 110 | 125 | 60 km | 30 km | 330 μm | 360 μm | B |
| Ex. 4 | MI-3 | 1,6-HDDA | UV-3000B | CB | 110 | 125 | 60 km | 30 km | 330 μm | 360 μm | B |
| Ex. 5 | MI-4 | 1,6-HDDA | UV-3000B | CB | 105 | 120 | 60 km | 30 km | 320 μm | 370 μm | B |
| Ex. 6 | MI-5 | 1,6-HDDA | UV-3000B | CB | 105 | 120 | 60 km | 30 km | 340 μm | 370 μm | B |
| Ex. 7 | MI-6 | 1,6-HDDA | UV-3000B | CB | 100 | 115 | 70 km | 40 km | 350 μm | 380 μm | B |
| Ex. 8 | MI-7 | 1,6-HDDA | UV-3000B | CB | 100 | 115 | 70 km | 40 km | 350 μm | 380 μm | B |
| Ex. 9 | MI-7 | TMPTA | UV-3000B | CB | 103 | 118 | 70 km | 38 km | 350 μm | 375 μm | B |
| Ex. 10 | MI-1 | 1,6-HDDA + | UV-3000B | CB | 100 | 115 | 70 km | 60 km | 350 μm | 380 μm | A |
| | | KBM-802 | | | | | | | | | |
| Ex. 11 | MI-4 | 1,6-HDDA + | UV-3000B | CB | 100 | 110 | 80 km | 70 km | 370 μm | 400 μm | A |
| | | KBM-802 | | | | | | | | | |
| Ex. 12 | MI-6 | 1,6-HDDA + | UV-3000B | CB | 100 | 100 | 100 km | 90 km | 390 μm | 420 μm | A |
| | | B-1 | | | | | | | | | |
| Ex. 13 | MI-8 | 1,6-HDDA + | UV-3000B | CB | 100 | 105 | 80 km | 70 km | 330 μm | 360 μm | B |
| | | B-1 | | | | | | | | | |
| Ex. 14 | MI-9 | 1,6-HDDA + | UV-3000B | CB | 100 | 105 | 80 km | 70 km | 330 μm | 360 μm | B |
| | | B-1 | | | | | | | | | |
| Ex. 15 | MI-10 | 1,6-HDDA + | UV-3000B | CB | 100 | 100 | 100 km | 90 km | 350 μm | 380 μm | B |
| | | B-1 | | | | | | | | | |
| Ex. 16 | MI-11 | 1,6-HDDA + | UV-3000B | CB | 100 | 100 | 100 km | 90 km | 350 μm | 380 μm | B |
| | | B-1 | | | | | | | | | |
| Ex. 17 | MI-1 | 1,6-HDDA | −LEC BL-1 | CB | 110 | 155 | 40 km | 10 km | 290 μm | 340 μm | A |
| Ex. 18 | MI-6 | 1,6-HDDA | TR2000 | CB | 110 | 150 | 40 km | 15 km | 280 μm | 300 μm | A |
| Comp. | Perbutyl Z | 1.6-HDDA | UV-3000B | CB | 125 | 200 | 25 km | 0.3 km | 280 μm | 310 μm | C |
| Ex. 1 | | | | | | | | | | | |
| Comp. | V-601 | 1,6-HDDA | UV-3000B | CB | 130 | 220 | 30 km | 0.5 km | 270 μm | 300 μm | D |
| Ex. 2 | | | | | | | | | | | |
| Comp. | I-1 | 1,6-HDDA | UV-3000B | CB | 130 | 190 | 30 km | 1 km | 280 μm | 310 μm | D |
| Ex. 3 | | | | | | | | | | | |
| Comp | I-2 | 1,6-HDDA | UV-3000B | CB | 120 | 180 | 30 km | 1 km | 260 μm | 300 μm | D |
| Ex. 4 | | | | | | | | | | | |
| Comp. | Benzo- | 1,6-HDDA | UV-3000B | CB | 120 | 180 | 30 km | 1 km | 70 μm | 300 μm | C |
| Ex. 5 | pinacol | | | | | | | | | | |
| Comp. | VPE-0401 | 1,6-HDDA | UV-3000B | CB | 140 | 180 | 10 km | 1 km | 70 μm | 290 μm | B |
| Ex. 6 | | | | | | | | | | | |

The abbreviations in Table 1 are as follows.

MI-1 (MI is an abbreviation for Macroinitiator): VPS-1001 (polydimethylsiloxane unit-containing macro azo initiator, Wako Pure Chemical Industries, Ltd.)<

### <Synthesis of MI-2>

A disulfide-containing diol (below), polypropylene glycol diol (number-average molecular weight 1,000, hereinafter abbreviated to PPG-1000), and 4,4′-diphenylmethane diisocyanate (hereinafter abbreviated to MDI) were subjected to polycondensation at 20:30:50 (molar ratio) in methyl ethyl ketone (polymerization concentration was 10 mass %) at 50° C. for 5 hours, thus giving MI-2 (Mw=22,000).

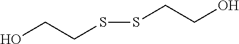

### <Synthesis of MI-3>

15.0 parts of the diamine compound shown below and 34.6 parts of N,N′-bis(3-aminophenyl)isophthalamide were dissolved in 375 parts of dimethylacetamide purified by distillation, subsequently 15.2 parts of isophthaloyl chloride and 4 parts of triethylamine were added, and a reaction was carried out at 10° C. to 15° C. for 4 hours. After the reaction was completed the reaction mixture was poured into water, thus precipitating a macromolecule compound. The macromolecule compound thus precipitated was washed twice with methanol and twice with diethyl ether and dried under reduced pressure at 25° C., thus giving MI-3 (Mw=15,000).

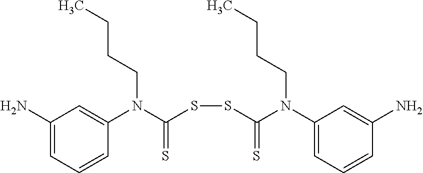 [SMILES: CCCCN(C(=S)SSC(=S)N(CCCC)c1cccc(N)c1)c1cccc(N)c1]

### <Synthesis of MI-4>

A polyester resin solution was produced by polycondensation of an alkoxyamine diol (below), 1,7-heptanediol, and adipic acid at 20:30:50 (molar ratio) in methyl ethyl ketone (polymerization concentration was 45 mass %) at 40° C. for 24 hours, and the solvent was distilled off, thus giving MI-4 (Mw=12,000).

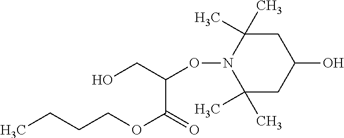 [SMILES: CCCCOC(=O)C(CO)ON1C(C)(C)CC(O)CC1(C)C]

### <Synthesis of MI-5>

A polyurethane resin solution was produced by polycondensation of an alkoxyamine diol (below), siloxanediol (Shin-Etsu Chemical Co., Ltd.) MDI at 20:30:50 (molar ratio) in methyl ethyl ketone (polymerization concentration was 15 mass %) at 30° C. for 24 hours, and the solvent was distilled off, thus giving MI-4 (Mw=18,000).

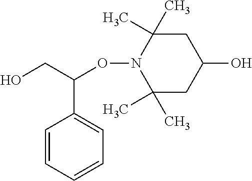 [SMILES: CC1(C)CC(O)CC(C)(C)N1OC(CO)c1ccccc1]

### <Synthesis of MI-6>

A flask flushed with nitrogen was charged with 4.6 parts of benzopinacol and 1.3 parts of di-n-butyltin dilaurate, and they were dissolved in 178.7 parts of 1-methyl-2-pyrrolidone. Subsequently, 18.8 parts of 1,3-bis(isocyanatomethyl)benzene was poured into the solution at 25° C., and a reaction was carried out at a reaction temperature of 25° C. for 24 hours, thus giving a solution of an isocyanate compound. Subsequently, a reaction vessel formed from a flask that had been flushed with nitrogen and a dropping funnel was prepared, the dropping funnel was charged with the solution of the isocyanate compound, the flask was charged with 8.1 parts of 1,4-butanediol, and the solution of the isocyanate compound was added dropwise at a polymerization temperature of 60° C. over 2 hours. Subsequently, the liquid temperature of the reaction solution was raised to 80° C., and a reaction was carried out for 1 hour, thus producing a solution of the target MI-6 (Mw=20,000). The solution thus obtained was poured into 890 parts of methanol to thus precipitate the MI-6, this was filtered, and the MI-6 on a filter paper was washed with 445 parts of methanol. Subsequently, the MI-6 was isolated by drying under reduced pressure at room temperature for 24 hours.

### <Synthesis of MI-7>

A flask flushed with nitrogen was charged with 0.8 parts (0.0023 mole eq.) of benzopinacol and 1.3 parts (0.002 mole eq.) of di-n-butyltin dilaurate, and they were dissolved in 162.6 parts of 1-methyl-2-pyrrolidone. Subsequently, 18.8 parts (0.1 mole eq.) of 1,3-bis(isocyanatomethyl)benzene was poured into the solution at 25° C., and a reaction was carried out at a reaction temperature of 25° C. for 24 hours, thus giving a solution of an isocyanate compound. Subsequently, a reaction vessel formed from a flask that had been flushed with nitrogen and a dropping funnel was prepared, the dropping funnel was charged with the solution of the isocyanate compound, the flask was charged with 0.03 mole eq. of X-22-160AS (a modified silicone oil having carbinol at both terminals produced by Shin-Etsu Chemical Co., Ltd.) and 0.07 mole eq. of 1,4-butanediol, and the solution of the isocyanate compound was added dropwise at a polymerization temperature of 60° C. over 2 hours. Subsequently, the liquid temperature of the reaction solution was raised to 80° C., and a reaction was carried out for 1 hour, thus producing a solution of the target MI-7 (Mw=32,000). The solution thus obtained was poured into 890 parts of methanol to thus precipitate the MI-7, this was filtered, and the MI-7 on a filter paper was washed with 445 parts of methanol. Subsequently, the MI-7 was isolated by drying under reduced pressure at room temperature for 24 hours.

### <Synthesis of MI-8>

A disulfide-containing diol (below), KF-6003 (both termini carbinol-modified silicone oil, Shin-Etsu Chemical Co., Ltd.), and 4,4′-diphenylmethane diisocyanate (hereinafter, abbreviated to MDI) were subjected to polycondensation at 20:30:50 (molar ratio) in methyl ethyl ketone (polymerization concentration was 10 mass %) at 50° C. for 5 hours, and after the reaction was completed the reaction mixture was poured into water, thus precipitating a macromolecule compound. The macromolecule compound thus precipitated was washed twice with methanol and twice with diethyl ether and dried under reduced pressure at 25° C., thus giving MI-8 (Mw=26,000).

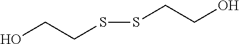

### <Synthesis of MI-9>

The diamine compound shown below, X-22-161A (both termini amino-modified silicone oil, Shin-Etsu Chemical Co., Ltd.), and isophthaloyl chloride were reacted at 20:30:50 (molar ratio) at 10° C. to 15° C. for 4 hours with 4 parts of triethylamine added. After the reaction was completed the reaction mixture was poured into water, thus precipitating a macromolecule compound. The macromolecule compound thus precipitated was washed twice with methanol and twice with diethyl ether and dried under reduced pressure at 25° C., thus giving MI-9 (Mw=20,000).

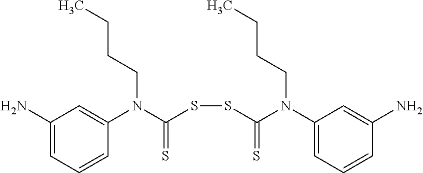 [SMILES: CCCCN(C(=S)SSC(=S)N(CCCC)c1cccc(N)c1)c1cccc(N)c1]

### <Synthesis of MI-10>

An alkoxyamine diol (below), 1,7-heptanediol, and adipoyl chloride were subjected to polycondensation at 20:30:50 (molar ratio) in methyl ethyl ketone (polymerization concentration was 45 mass %) at 40° C. for 24 hours, and after the reaction was completed the reaction mixture was poured into water, thus precipitating a macromolecule compound. The macromolecule compound thus precipitated was washed twice with methanol and twice with diethyl ether and dried under reduced pressure at 25° C., thus giving MI-10 (Mw=27,000).

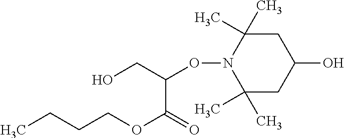 [SMILES: CCCCOC(=O)C(CO)ON1C(C)(C)CC(O)CC1(C)C]

### <Synthesis of MI-11>

MI-11 (Mw=21,000) was synthesized and isolated by the same procedure as for MI-7 except that benzopinacol:1,3-bis(isocyanatomethyl)benzene:1,4-butanediol:KF-6003 (both termini carbinol-modified silicone oil, Shin-Etsu Chemical Co., Ltd.) were used at 5:50:30:20 (molar ratio).

Perbutyl Z: compound below, t-butylperoxybenzoate (NOF Corporation)
V-601: dimethyl 2,2′-azobis(2-methylpropionate), Wako Pure Chemical Industries, Ltd.
I-1: compound below
I-2: compound below

### Benzopinacol: Tokyo Chemical Industry Co., Ltd.

VPE-0401: polyethylene glycol unit-containing macro azo initiator, Wako Pure Chemical Industries, Ltd.
1,6-HDDA: compound below, 1,6-hexanediol diacrylate
TMPTA: trimethylolpropane triacrylate
KBM-802: compound below, 3-mercaptopropylmethyldimethoxysilane (Shin-Etsu Chemical Co., Ltd.)
B-1: compound below
UV-3000B: Shikoh UV-3000B, urethane acrylate resin, The Nippon Synthetic Chemical Industry Co., Ltd., Tg: about 36° C.
S-LEC BL-1H: polyvinyl butyral, Sekisui Chemical Co., Ltd., Tg: about 68° C.
TR2000: synthetic rubber SBR, JSR, Tg: about −65° C. and about 105° C.
CB: carbon black, Ketjen Black EC600JD (Lion Corporation)

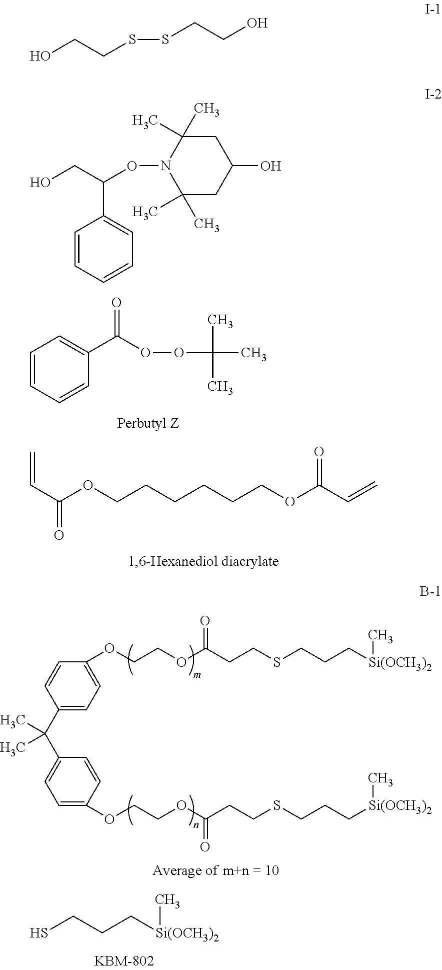

From the results above, in accordance with the present invention, there can be provided a resin composition for laser engraving that can give a flexographic printing plate having good durability toward both an aqueous ink and a solvent ink, a flexographic printing plate precursor employing the resin composition for laser engraving and a process for producing same, a process for making a flexographic printing plate employing same, and a flexographic printing plate obtained thereby.

It has been found that, in accordance with the present invention, there can also be provided a flexographic printing plate having high laser engraving sensitivity and good engraving residue rinsing properties.

What is claimed is:

1. A resin composition for laser engraving, comprising:
(Component A) a macroinitiator having a structure represented by any one of Formulae Ito V below obtained by step-growth polymerization; and
(Component B) a polymerizable compound, 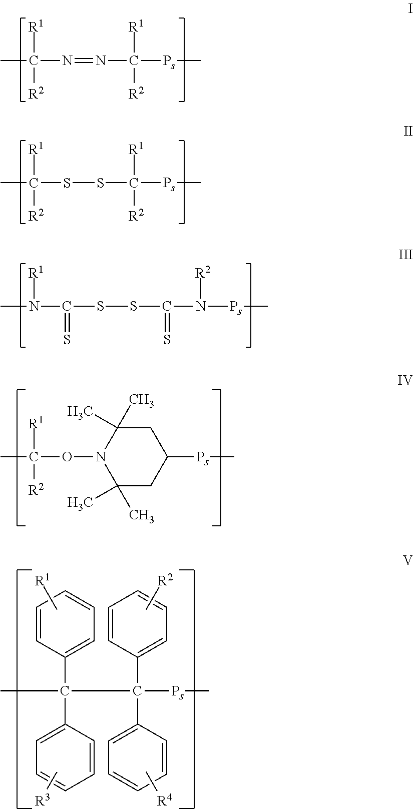
wherein in Formula I, Ps denotes a polysiloxane skeleton, in Formulae II to V, Ps denotes a main chain skeleton obtained by step-growth polymerization, and in Formulae I to V, R¹ to R⁴ independently denote a hydrogen atom, a halogen atom, or a monovalent organic group.

2. The resin composition for laser engraving according to claim 1, wherein Component A comprises a structure represented by Formula IV or Formula V.

3. The resin composition for laser engraving according to claim 1, wherein it further comprises (Component C) a binder having no polymerization-initiating ability.

4. The resin composition for laser engraving according to claim 1, wherein Component B comprises at least an ethylenically unsaturated compound.

5. The resin composition for laser engraving according to claim 1, wherein Component B is at least one selected from the group consisting of a (meth)acrylic acid ester, a styrene, and acrylonitrile.

6. The resin composition for laser engraving according to claim 1, wherein in Formulae II to V, Ps of Component A is at least one skeleton selected from the group consisting of a polyester skeleton, a polyurethane skeleton, a polyurethane urea skeleton, a polyamide skeleton, a polyalkylene glycol skeleton, and a polysiloxane skeleton.

7. The resin composition for laser engraving according to claim 1, wherein Component B comprises a (meth)acrylate compound and a compound having at least one type from a hydrolyzable silyl group and a silanol group.

8. The resin composition for laser engraving according to claim 1, wherein it further comprises (Component D) a photothermal conversion agent.

9. The resin composition for laser engraving according to claim 8, wherein Component D is carbon black.

10. The resin composition for laser engraving according to claim 3, wherein Component C is a compound selected from the group consisting of a urethane(meth)acrylate, a polyvinyl butyral, and a styrene butadiene rubber.

11. The resin composition for laser engraving according to claim 3, wherein Component C is a urethane(meth)acrylate.

12. A flexographic printing plate precursor for laser engraving comprising a relief-forming layer comprising the resin composition for laser engraving according to claim 1.

13. A flexographic printing plate precursor for laser engraving comprising a crosslinked relief-forming layer formed by crosslinking, by means of light and/or heat, a relief-forming layer comprising the resin composition for laser engraving according to claim 1.

14. A process for producing a flexographic printing plate precursor for laser engraving, comprising:
a layer formation step of forming a relief-forming layer comprising the resin composition for laser engraving according to claim 1; and
a crosslinking step of crosslinking the relief-forming layer by means of light and/or heat to thus obtain a flexographic printing plate precursor comprising a crosslinked relief-forming layer.

15. The process for producing a flexographic printing plate precursor for laser engraving according to claim 14, wherein the crosslinking step is a step of crosslinking the relief-forming layer by means of heat to thus obtain a flexographic printing plate precursor comprising a crosslinked relief-forming layer.

16. A process for making a flexographic printing plate, comprising:
an engraving step of laser-engraving a flexographic printing plate precursor for laser engraving comprising a crosslinked relief-forming layer formed by crosslinking a relief-forming layer comprising the resin composition for laser engraving according to claim 1 by means of light and/or heat, to thus form a relief layer.

17. A flexographic printing plate comprising a relief layer made by the process for making a flexographic printing plate according to claim 16.
